(19) United States
(12) Patent Application Publication
(10) Pub. No.: US 2011/0088418 A1
(43) Pub. Date: Apr. 21, 2011

(54) COMPOSITIONS COMPRISING IONIC LIQUIDS AND FLUOROOLEFINS AND USE THEREOF IN ABSORPTION CYCLE SYSTEMS

(76) Inventors: Konstantinos Kontomaris, Hockessin, DE (US); Nandini C. Mouli, Reisterstown, MD (US); Mark Brandon Shiflett, Wilmington, DE (US)

(21) Appl. No.: 12/999,082

(22) PCT Filed: Jul. 8, 2009
(86) PCT No.: PCT/US2009/049869

§ 371 Date: Dec. 15, 2010

Related U.S. Application Data
(60) Provisional application No. 61/078,981, filed on Jul. 8, 2008.

(51) Int. Cl. F25B 15/00; C09K 5/04

(52) U.S. Cl. 62/101; 252/67; 62/476

(57) ABSTRACT

Disclosed herein are compositions comprising at least one ionic liquid and at least one fluoroolefin. Such compositions may be useful as absorbent/working fluid pairs in absorption cycle systems for providing cooling or heat.

### BACKGROUND

1. Field of the Disclosure

The present disclosure relates to compositions comprising at least one ionic liquid and at least one fluoroolefin. These compositions are useful as working fluid pairs in absorption cycle systems.

The present disclosure relates to compositions comprising at least one ionic liquid and at least one fluoroolefin. These compositions are useful as working fluid pairs in absorption cycle systems.

2. Description of Related Art

New environmental regulations on working fluids have forced the refrigeration and air-conditioning industry to look for new working fluids with low global warming potential (GWP). There are numerous other applications for fluorocarbon working fluids, such as in the area of fire suppression, in preparation of foams as expansion agents, and as aerosol propellants, to mention a few.

Most currently used absorption cycle systems use water as the refrigerant and LiBr as the absorbent. The use of water requires operation at pressures substantially lower than atmospheric pressure resulting in systems of large size and high cost. The use of highly corrosive LiBr requires expensive materials of construction, imposes higher maintenance costs, reduces the useful life of the equipment and necessitates the use of environmentally harmful chromate corrosion inhibitors that prevents penetration into markets where heavy metals are banned. Moreover, precipitation of LiBr from LiBr-water solutions limits the range of feasible operating conditions thus limiting the energy efficiency of the absorption cycle and preventing use of innovations such as the use of air-cooled condensers and absorbers. Air-cooled operation eliminates the need for water cooling towers and their associated first costs, operation costs, maintenance costs, space requirements, and consumption of large quantities of water (a limited resource in some areas of the world).

Some currently used absorption cycle systems use ammonia as the refrigerant and water as the absorbent. Ammonia is toxic, flammable and corrosive. The use of volatile water as the absorbent requires a rectifier to capture water vapor escaping from the generator and provide anhydrous ammonia to the condenser. The rectifier adds to the system start-up cost and to the operating costs throughout the life of the system due to the additional required energy consumption.

Replacement working fluids are being sought for absorption cycle systems that have low GWP, no toxicity, non-flammability, reasonable cost and performance to match existing systems.

### SUMMARY OF THE INVENTION

Disclosed herein is a composition comprising at least one ionic liquid and at least one fluoroolefin, wherein said composition comprises at least about 1 weight percent of said at least one fluoroolefin.

Also disclosed herein is a process for producing cooling comprising forming a refrigerant/absorbent mixture, heating said mixture to release refrigerant vapor, condensing said refrigerant to form liquid refrigerant, evaporating said liquid refrigerant in the vicinity of a heat transfer fluid, transferring said heat transfer fluid to the vicinity of a body to be cooled, and reforming the absorbent/refrigerant solution; wherein said refrigerant/absorbent mixture comprises at least one ionic liquid and at least one fluoroolefin.

Also disclosed herein is a process for transferring heat comprising moving a heat transfer fluid from a heat source to a heat sink, wherein the heat source is an absorption cycle utilizing a working fluid pair comprising at least one ionic liquid and at least one fluoroolefin.

Also disclosed herein is an absorption cycle system apparatus comprising an absorber, a generator, a condenser, an expansion device, and an evaporator, wherein the working fluids contained within said apparatus comprise at least one ionic liquid and at least one fluoroolefin.

### BRIEF DESCRIPTION OF THE DRAWINGS

The present invention may be better understood with reference to the following figures, wherein:

FIG. 1 is a schematic diagram of one embodiment of a typical vapor compression heat transfer system.

FIG. 2 is a schematic diagram of one embodiment of an absorption cycle system.

FIG. 3 shows measured isothermal solubility data (in mole percent) for the system trans-HFO-1336mzz+[emim][Tf₂N] as a function of pressure for 6 different temperatures. Filled diamonds (♦) represent measured isothermal data at 20.1° C., filled squares (▪) represent measured isothermal data at 30.0° C., filled triangles (▴) represent measured isothermal data at 49.5° C., cross marks (x) represent measured isothermal data at 59.9° C., stars (*) represent measured isothermal data at 69.9° C., and filled circles () represent measured isothermal data at 79.8° C. Solid lines represent data trends.

FIG. 4 shows measured isothermal solubility data (in mole percent) for the system cis-HFO-1336mzz+[emim][Tf2N] as a function of pressure for 6 different temperatures. Filled diamonds (♦) represent measured isothermal data at 20.1° C., filled squares (▪) represent measured isothermal data at 30.0° C., filled triangles (▴) represent measured isothermal data at 49.5° C., cross marks (x) represent measured isothermal data at 59.9° C., stars (*) represent measured isothermal data at 69.9° C., and filled circles () represent measured isothermal data at 79.8° C. Solid lines represent data trends.

### DETAILED DESCRIPTION OF THE INVENTION

The present invention provides a composition comprising at least one ionic liquid and at least one fluoroolefin.

A heat transfer medium (also referred to herein as a heat transfer fluid, a heat transfer composition or a heat transfer fluid composition) is a working fluid used to carry heat from a heat source to a heat sink.

A refrigerant is a compound or mixture of compounds that function as a heat transfer fluid in a cycle wherein the fluid sometimes undergoes a phase change from a liquid to a gas and back. In certain instances, a refrigerant may not undergo a phase change, such as for carbon dioxide. In absorption cycle systems, a refrigerant is the volatile component of a working fluid pair.

A working fluid pair is a pair of fluids comprising an absorbent and a refrigerant used to provide the cooling or heating in an absorption cycle system. In general, the working fluids will have an affinity for one another, e.g. solubility of one in the other.

An absorbent is a working fluid that is the non-volatile component of a working fluid pair as used in an absorption cycle system.

An absorption cycle system is any system that produces heating or cooling by use of a working fluid pair and the absorption effect as described herein. In one embodiment, an absorption cycle system comprises an absorption chiller that produces cooling. In another embodiment, an absorption cycle system comprises an absorption heat pump that may produce heat or cooling. In another embodiment, an absorption cycle system comprises an absorption heater. Absorption cycle systems are used to provide cooling or heating in areas with no, or little access to electricity. Additionally, absorption cycle systems provide more efficient use of power resources.

In one embodiment, disclosed herein are compositions comprising working fluid pairs.

In one embodiment, disclosed are compositions comprising at least one ionic liquid and at least one fluoroolefin. In one embodiment, the disclosed compositions function as working fluid pairs in absorption cycle systems.

Ionic liquids are organic compounds that are liquid at temperatures below 100° C. They differ from most salts in that they have low melting points, they tend to be liquid over a wide temperature range, and have been shown to have high heat capacities. Ionic liquids have essentially no vapor pressure, and they can either be neutral, acidic or basic. The properties of an ionic liquid can be tailored by varying the cation and anion. A cation or anion of an ionic liquid useful for the present invention can, in principle, be any cation or anion such that the cation and anion together form an organic salt that is liquid at or below about 100° C.

Many ionic liquids are formed by reacting a nitrogen-containing heterocyclic ring, preferably a heteroaromatic ring, with an alkylating agent (for example, an alkyl halide) to form a quaternary nitrogen-containing salt, and performing ion exchange or other suitable reactions with various Lewis acids or their conjugate bases to form the ionic liquid. Examples of suitable heteroaromatic rings include substituted pyridines, imidazole, substituted imidazole, pyrrole and substituted pyrroles. These rings can be alkylated with virtually any straight, branched or cyclic C₁₋₂₀ alkyl group, but preferably, the alkyl groups are C₁₋₁₆ groups, since groups larger than this may produce low melting solids rather than ionic liquids. Various triarylphosphines, thioethers and cyclic and non-cyclic quaternary ammonium salts may also be used for this purpose. Counterions that may be used include chloroaluminate, bromoaluminate, gallium chloride, tetrafluoroborate, tetrachloroborate, hexafluorophosphate, nitrate, trifluoromethane sulfonate, methylsulfonate, p-toluenesulfonate, hexafluoroantimonate, hexafluoroarsenate, tetrachloroaluminate, tetrabromoaluminate, perchlorate, hydroxide anion, copper dichloride anion, iron trichloride anion, zinc trichloride anion, as well as various lanthanum, potassium, lithium, nickel, cobalt, manganese, and other metal-containing anions.

Ionic liquids may also be synthesized by salt metathesis, by an acid-base neutralization reaction or by quaternizing a selected nitrogen-containing compound; or they may be obtained commercially from several companies such as Merck (Darmstadt, Germany) or BASF (Mount Olive, N.J.).

Representative examples of ionic liquids useful herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references therein cited). In one embodiment, a library, i.e. a combinatorial library, of ionic liquids may be prepared, for example, by preparing various alkyl derivatives of a quaternary nitrogen-containing cation, and varying the associated anions. The acidity of the ionic liquids can be adjusted by varying the molar equivalents and type and combinations of Lewis acids.

In one embodiment, ionic liquids suitable for use herein include those having cations selected from the following formulae:

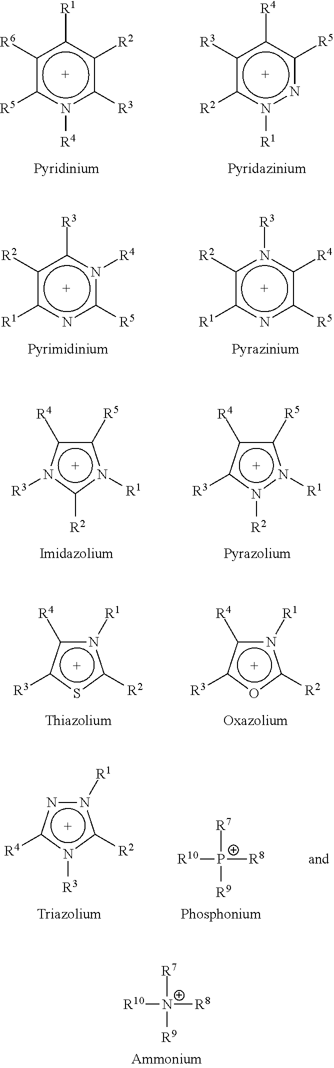

wherein R¹, R², R³, R⁴, R⁵ and R⁶ are independently selected from the group consisting of:
(i) H;
(ii) halogen;
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to O₂₀ unsubstituted aryl, or C₃ to C₂₅ unsubstituted heteroaryl having one to three heteroatoms independently selected from the group consisting of O, N, Si and S; and
(vi) C₆ to O₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
   (2) OH,
   (3) NH₂, and
   (4) SH;
      and wherein R⁷, R⁸, R⁹ and R¹⁰ are independently selected from the group consisting of:
(i) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₂₅ unsubstituted aryl, or O₃ to C₂₅ unsubstituted heteroaryl having one to three heteroatoms independently selected from the group consisting of O, N, Si and S; and
(iv) C₆ to C₂₅ substituted aryl, or C₃ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
   (2) OH,
   (3) NH₂, and
   (4) SH;
      and wherein, optionally, at least two of R¹, R², R³, R⁴, R⁵, R⁶, R⁷, R⁸, R⁹ and R¹⁰ together form a cyclic or bicyclic alkanyl or alkenyl group.

In another embodiment, ionic liquids useful for the invention comprise fluorinated cations wherein at least one member selected from R¹, R², R³, R⁴, R⁵, R⁶, R⁷, R⁸, R⁹ and R¹⁰ comprises F⁻.

In another embodiment, ionic liquids useful for the invention comprise imidazolium, such as 1-ethyl-3-methylimidazolium and 1-butyl-3-methylimidazolium.

In one embodiment, ionic liquids useful herein have anions selected from the group consisting of [CH₃CO₂]⁻, [HSO₄]⁻, [CH₃OSO₃]⁻, [C₂H_{S}OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻; and preferably any fluorinated anion. Fluorinated anions useful herein include [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻; and F⁻.

In another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion. In yet another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above; and an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

In still another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above, wherein at least one member selected from R¹, R², R³, R⁴, R⁵, R⁶, R⁷, R⁸, R⁹, and R¹⁹ comprises F⁻; and an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, and any fluorinated anion. In still another embodiment, ionic liquids suitable for use herein may have a cation selected from the group consisting of pyridinium, pyridazinium, pyrimidinium, pyrazinium, imidazolium, pyrazolium, thiazolium, oxazolium, triazolium, phosphonium, and ammonium as defined above, wherein at least one member selected from R¹, R², R³, R⁴, R⁵, R⁶, R⁷, R⁸, R⁹, and R¹⁰ comprises F⁻; and an anion selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃Cl]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and F⁻.

In one embodiment, the ionic liquid comprises imidazolium as the cation and [BF₄]⁻ or [PF₆]⁻ as the anion. In another embodiment, the ionic liquid comprises 1-ethyl-3-methylimidazolium (also referred to herein as Emim) or 1-butyl-3-methylimidazolium (also referred to herein as Bmim) as the cation, and [BF₄]⁻ or [PF₆]⁻ as the anion.

In one embodiment, the present compositions comprise at least one ionic liquid and at least one fluoroolefin. In some embodiments, fluoroolefins are compounds, which comprise carbon atoms, fluorine atoms and optionally hydrogen or chlorine atoms. In one embodiment, the fluoroolefins used in the compositions of the present invention comprise compounds with 2 to 12 carbon atoms. In another embodiment the fluoroolefins comprise compounds with 3 to 10 carbon atoms, and in yet another embodiment the fluoroolefins comprise compounds with 3 to 7 carbon atoms. Representative fluoroolefins include but are not limited to all compounds as listed in Table 1, Table 2, and Table 3.

One embodiment of the present invention provides fluoroolefins having the formula E- or Z—R¹CH═CHR² (Formula I), wherein R¹ and R² are, independently, C₁ to C₆ perfluoroalkyl groups. Examples of R¹ and R² groups include, but are not limited to, CF₃, C₂F₅, CF₂CF₂CF₃, CF(CF₃)₂, CF₂CF₂CF₂CF₃, CF(CF₃)CF₂CF₃, CF₂CF(CF₃)₂, C(CF₃)₃, CF₂CF₂CF₂CF₂CF₃, CF₂CF₂CF(CF₃)₂, C(CF₃)₂C₂F₅, CF₂CF₂CF₂CF₂CF₂CF₃, CF(CF₃)CF₂CF₂C₂F₅, and C(CF₃)₂CF₂C₂F₅. In one embodiment the fluoroolefins of Formula I have at least 4 carbon atoms in the molecule. In another embodiment, the fluoroolefins of Formula I have at least 5 carbon atoms in the molecule. Exemplary, non-limiting Formula I compounds are presented in Table 1.

TABLE 1

| Code | Structure | Chemical Name |
|---|---|---|
| F11E | CF₃CH═CHCF₃ | 1,1,1,4,4,4-hexafluorobut-2-ene |
| F12E | CF₃CH═CHC₂F₅ | 1,1,1,4,4,5,5,5-octafluoropent-2-ene |
| F13E | CF₃CH═CHCF₂C₂F₅ | 1,1,1,4,4,5,5,6,6,6-decafluorohex-2-ene |
| F13iE | CF₃CH═CHCF(CF₃)₂ | 1,1,1,4,5,5,5-heptafluoro-4-(trifluoromethyl)pent-2-ene |
| F22E | C₂F₅CH═CHC₂F₅ | 1,1,1,2,2,5,5,6,6,6-decafluorohex-3-ene |
| F14E | CF₃CH═CH(CF₂)₃CF₃ | 1,1,1,4,4,5,5,6,6,7,7,7-dodecafluorohept-2-ene |
| F14iE | CF₃CH═CHCF₂CF—(CF₃)₂ | 1,1,1,4,4,5,6,6,6-nonafluoro-5-(trifluoromethyl)hex-2-ene |
| F14sE | CF₃CH═CHCF(CF₃)—C₂F₅ | 1,1,1,4,5,5,6,6,6-nonfluoro-4-(trifluoromethyl)hex-2-ene |
| F14tE | CF₃CH═CHC(CF₃)₃ | 1,1,1,5,5,5-hexafluoro-4,4-bis(trifluoromethyl)pent-2-ene |
| F23E | C₂F₅CH═CHCF₂C₂F₅ | 1,1,1,2,2,5,5,6,6,7,7,7-dodecafluorohept-3-ene |
| F23iE | C₂F₅CH═CHCF(CF₃)₂ | 1,1,1,2,2,5,6,6,6-nonafluoro-5-(trifluoromethyl)hex-3-ene |
| F15E | CF₃CH═CH(CF₂)₄CF₃ | 1,1,1,4,4,5,5,6,6,7,7,8,8,8-tetradecafluorooct-2-ene |
| F15iE | CF₃CH═CH—CF₂CF₂CF(CF₃)₂ | 1,1,1,4,4,5,5,6,7,7,7-undecafluoro-6-(trifluoromethyl)hept- |
| | | 2-ene |
| F15tE | CF₃CH═CH—C(CF₃)₂C₂F₅ | 1,1,1,5,5,6,6,6-octafluoro-4,4-bis(trifluoromethyl)hex-2- |
| | | ene |
| F24E | C₂F₅CH═CH(CF₂)₃CF₃ | 1,1,1,2,2,5,5,6,6,7,7,8,8,8-tetradecafluorooct-3-ene |
| F24iE | C₂F₅CH═CHCF₂CF—(CF₃)₂ | 1,1,1,2,2,5,5,6,7,7,7-undecafluoro-6-(trifluoromethyl)hept- |
| | | 3-ene |
| F24sE | C₂F₅CH═CHCF(CF₃)—C₂F₅ | 1,1,1,2,2,5,6,6,7,7,7-undecafluoro-5-(trifluoromethyl)hept- |
| | | 3-ene |
| F24tE | C₂F₅CH═CHC(CF₃)₃ | 1,1,1,2,2,6,6,6-octafluoro-5,5-bis(trifluoromethyl)hex-3- |
| | | ene |
| F33E | C₂F₅CF₂CH═CH—CF₂C₂F₅ | 1,1,1,2,2,3,3,6,6,7,7,8,8,8-tetradecafluorooct-4-ene |
| F3i3iE | (CF₃)₂CFCH═CH—CF(CF₃)₂ | 1,1,1,2,5,6,6,6-octafluoro-2,5-bis(trifluoromethyl)hex-3- |
| | | ene |
| F33iE | C₂F₅CF₂CH═CH—CF(CF₃)₂ | 1,1,1,2,5,5,6,6,7,7,7-undecafluoro-2-(trifluoromethyl)hept- |
| | | 3-ene |
| F16E | CF₃CH═CH(CF₂)₅CF₃ | 1,1,1,4,4,5,5,6,6,7,7,8,8,,9,9,9-hexadecafluoronon-2-ene |
| F16sE | CF₃CH═CHCF(CF₃)(CF₂)₂C₂F₅ | 1,1,1,4,5,5,6,6,7,7,8,8,8-tridecafluoro-4- |
| | | (trifluoromethyl)hept-2-ene |
| F16tE | CF₃CH═CHC(CF₃)₂CF₂C₂F₅ | 1,1,1,6,6,6-octafluoro-4,4-bis(trifluoromethyl)hept-2-ene |
| F25E | C₂F₅CH═CH(CF₂)₄CF₃ | 1,1,1,2,2,5,5,6,6,7,7,8,8,9,9,9-hexadecafluoronon-3-ene |
| F25iE | C₂F₅CH═CH—CF₂CF₂CF(CF₃)₂ | 1,1,1,2,2,5,5,6,6,7,8,8,8-tridecafluoro-7- |
| | | (trifluoromethyl)oct-3-ene |
| F25tE | C₂F₅CH═CH—C(CF₃)₂C₂F₅ | 1,1,1,2,2,6,6,7,7,7-decafluoro-5,5- |
| | | bis(trifluoromethyl)hept-3-ene |
| F34E | C₂F₅CF₂CH═CH—(CF₂)₃CF₃ | 1,1,1,2,2,3,3,6,6,7,7,8,8,9,9,9-hexadecafluoronon-4-ene |
| F34iE | C₂F₅CF₂CH═CH—CF₂CF(CF₃)₂ | 1,1,1,2,2,3,3,6,6,7,8,8,8-tridecafluoro-7- |
| | | (trifluoromethyl)oct-4-ene |
| F34sE | C₂F₅CF₂CH═CH—CF(CF₃)C₂F₅ | 1,1,1,2,2,3,3,6,7,7,8,8,8-tridecafluoro-6- |
| | | (trifluoromethyl)oct-4-ene |
| F34tE | C₂F₅CF₂CH═CH—C(CF₃)₃ | 1,1,1,5,5,6,6,7,7,7-decafluoro-2,2- |
| | | bis(trifluoromethyl)hept-3-ene |
| F3i4E | (CF₃)₂CFCH═CH—(CF₂)₃CF₃ | 1,1,1,2,5,5,6,6,7,7,8,8,8-tridecafluoro- |
| | | 2(trifluoromethyl)oct-3-ene |
| F3i4iE | (CF₃)₂CFCH═CH—CF₂CF(CF₃)₂ | 1,1,1,2,5,5,6,7,7,7-decafluoro-2,6- |
| | | bis(trifluoromethyl)hept-3-ene |
| F3i4sE | (CF₃)₂CFCH═CH—CF(CF₃)C₂F₅ | 1,1,1,2,5,6,6,7,7,7-decafluoro-2,5- |
| | | bis(trifluoromethyl)hept-3-ene |
| F3i4tE | (CF₃)₂CFCH═CH—C(CF₃)₃ | 1,1,1,2,6,6,6-heptafluoro-2,5,5-tris(trifluoromethyl)hex-3- |
| | | ene |
| F26E | C₂F₅CH═CH(CF₂)₅CF₃ | 1,1,1,2,2,5,5,6,6,7,7,8,8,9,9,10,10,10-octadecafluorodec- |
| | | 3-ene |
| F26sE | C₂F₅CH═CHCF(CF₃)(CF₂)₂C₂F₅ | 1,1,1,2,2,5,6,6,7,7,8,8,9,9,9-pentadecafluoro-5- |
| | | (trifluoromethyl)non-3-ene |
| F26tE | C₂F₅CH═CHC(CF₃)₂CF₂C₂F₅ | 1,1,1,2,2,6,6,7,7,8,8,8-dodecafluoro-5,5- |
| | | bis(trifluoromethyl)oct-3-ene |
| F35E | C₂F₅CF₂CH═CH—(CF₂)₄CF₃ | 1,1,1,2,2,3,3,6,6,7,7,8,8,9,9,10,10,10-octadecafluorodec- |
| | | 4-ene |
| F35iE | C₂F₅CF₂CH═CH—CF₂CF₂CF(CF₃)₂ | 1,1,1,2,2,3,3,6,6,7,7,8,9,9,9-pentadecafluoro-8- |
| | | (trifluoromethyl)non-4-ene |
| F35tE | C₂F₅CF₂CH═CH—C(CF₃)₂C₂F₅ | 1,1,1,2,2,3,3,7,7,8,8,8-dodecafluoro-6,6- |
| | | bis(trifluoromethyl)oct-4-ene |
| F3i5E | (CF₃)₂CFCH═CH—(CF₂)₄CF₃ | 1,1,1,2,5,5,6,6,7,7,8,8,9,9,9-pentadecafluoro-2- |
| | | (trifluoromethyl)non-3-ene |
| F3i5iE | (CF₃)₂CFCH═CH—CF₂CF₂CF(CF₃)₂ | 1,1,1,2,5,5,6,6,7,8,8,8-dodecafluoro-2,7- |
| | | bis(trifluoromethyl)oct-3-ene |
| F3i5tE | (CF₃)₂CFCH═CH—C(CF₃)₂C₂F₅ | 1,1,1,2,6,6,7,7,7-nonafluoro-2,5,5- |
| | | tris(trifluoromethyl)hept-3-ene |
| F44E | CF₃(CF₂)₃CH═CH—(CF₂)₃CF₃ | 1,1,1,2,2,3,3,4,4,7,7,8,8,9,9,10,10,10-octadecafluorodec- |
| | | 5-ene |
| F44iE | CF₃(CF₂)₃CH═CH—CF₂CF(CF₃)₂ | 1,1,1,2,3,3,6,6,7,7,8,8,9,9,9-pentadecafluoro-2- |
| | | (trifluoromethyl)non-4-ene |
| F44sE | CF₃(CF₂)₃CH═CH—CF(CF₃)C₂F₅ | 1,1,1,2,2,3,6,6,7,7,8,8,9,9,9-pentadecafluoro-3- |
| | | (trifluoromethyl)non-4-ene |
| F44tE | CF₃(CF₂)₃CH═CH—C(CF₃)₃ | 1,1,1,5,5,6,6,7,7,8,8,8-dodecafluoro-2,2,- |
| | | bis(trifluoromethyl)oct-3-ene |
| F4i4iE | (CF₃)₂CFCF₂CH═CH—CF₂CF(CF₃)₂ | 1,1,1,2,3,3,6,6,7,8,8,8-dodecafluoro-2,7- |
| | | bis(trifluoromethyl)oct-4-ene |
| F4i4sE | (CF₃)₂CFCF₂CH═CH—CF(CF₃)C₂F₅ | 1,1,1,2,3,3,6,7,7,8,8,8-dodecafluoro-2,6- |
| | | bis(trifluoromethyl)oct-4-ene |
| F4i4tE | (CF₃)₂CFCF₂CH═CH—C(CF₃)₃ | 1,1,1,5,5,6,7,7,7-nonafluoro-2,2,6- |
| | | tris(trifluoromethyl)hept-3-ene |
| F4s4sE | C₂F₅CF(CF₃)CH═CH—CF(CF₃)C₂F₅ | 1,1,1,2,2,3,6,7,7,8,8,8-dodecafluoro-3,6- |
| | | bis(trifluoromethyl)oct-4-ene |
| F4s4tE | C₂F₅CF(CF₃)CH═CH—C(CF₃)₃ | 1,1,1,5,6,6,7,7,7-nonafluoro-2,2,5- |
| | | tris(trifluoromethyl)hept-3-ene |
| F4t4tE | (CF₃)₃CCH═CH—C(CF₃)₃ | 1,1,1,6,6,6-hexafluoro-2,2,5,5- |
| | | tetrakis(trifluoromethyl)hex-3-ene |

Compounds of Formula I may be prepared by contacting a perfluoroalkyl iodide of the formula R¹I with a perfluoroalkyltrihydroolefin of the formula R²CH═CH₂ to form a trihydroiodoperfluoroalkane of the formula R¹CH₂CHIR². This trihydroiodoperfluoroalkane can then be dehydroiodinated to form R¹CH═CHR². Alternatively, the olefin R¹CH═CHR² may be prepared by dehydroiodination of a trihydroiodoperfluoroalkane of the formula R¹CHICH₂R² formed in turn by reacting a perfluoroalkyl iodide of the formula R²I with a perfluoroalkyltrihydroolefin of the formula R¹CH═CH₂.

The contacting of a perfluoroalkyl iodide with a perfluoroalkyltrihydroolefin may take place in batch mode by combining the reactants in a suitable reaction vessel capable of operating under the autogenous pressure of the reactants and products at reaction temperature. Suitable reaction vessels include fabricated from stainless steels, in particular of the austenitic type, and the well-known high nickel alloys such as Monel® nickel-copper alloys, Hastelloy® nickel based alloys and Inconel® nickel-chromium alloys.

Alternatively, the reaction may take be conducted in semi-batch mode in which the perfluoroalkyltrihydroolefin reactant is added to the perfluoroalkyl iodide reactant by means of a suitable addition apparatus such as a pump at the reaction temperature.

The ratio of perfluoroalkyl iodide to perfluoroalkyltrihydroolefin should be between about 1:1 to about 4:1, preferably from about 1.5:1 to 2.5:1. Ratios less than 1.5:1 tend to result in large amounts of the 2:1 adduct as reported by Jeanneaux, et. al. in Journal of Fluorine Chemistry, Vol. 4, pages 261-270 (1974).

Preferred temperatures for contacting of said perfluoroalkyl iodide with said perfluoroalkyltrihydroolefin are preferably within the range of about 150° C. to 300° C., preferably from about 170° C. to about 250° C., and most preferably from about 180° C. to about 230° C.

Suitable contact times for the reaction of the perfluoroalkyl iodide with the perfluoroalkyltrihydroolefin are from about 0.5 hour to 18 hours, preferably from about 4 to about 12 hours.

The trihydroiodoperfluoroalkane prepared by reaction of the perfluoroalkyl iodide with the perfluoroalkyltrihydroolefin may be used directly in the dehydroiodination step or may preferably be recovered and purified by distillation prior to the dehydroiodination step.

The dehydroiodination step is carried out by contacting the trihydroiodoperfluoroalkane with a basic substance. Suitable basic substances include alkali metal hydroxides (e.g., sodium hydroxide or potassium hydroxide), alkali metal oxide (for example, sodium oxide), alkaline earth metal hydroxides (e.g., calcium hydroxide), alkaline earth metal oxides (e.g., calcium oxide), alkali metal alkoxides (e.g., sodium methoxide or sodium ethoxide), aqueous ammonia, sodium amide, or mixtures of basic substances such as soda lime. Preferred basic substances are sodium hydroxide and potassium hydroxide.

Said contacting of the trihydroiodoperfluoroalkane with a basic substance may take place in the liquid phase preferably in the presence of a solvent capable of dissolving at least a portion of both reactants. Solvents suitable for the dehydroiodination step include one or more polar organic solvents such as alcohols (e.g., methanol, ethanol, n-propanol, isopropanol, n-butanol, isobutanol, and tertiary butanol), nitriles (e.g., acetonitrile, propionitrile, butyronitrile, benzonitrile, or adiponitrile), dimethyl sulfoxide, N,N-dimethylformamide, N,N-dimethylacetamide, or sulfolane. The choice of solvent may depend on the boiling point product and the ease of separation of traces of the solvent from the product during purification. Typically, ethanol or isopropanol are good solvents for the reaction.

Typically, the dehydroiodination reaction may be carried out by addition of one of the reactants (either the basic substance or the trihydroiodoperfluoroalkane) to the other reactant in a suitable reaction vessel. Said reaction may be fabricated from glass, ceramic, or metal and is preferably agitated with an impeller or stirring mechanism.

Temperatures suitable for the dehydroiodination reaction are from about 10° C. to about 100° C., preferably from about 20° C. to about 70° C. The dehydroiodination reaction may be carried out at ambient pressure or at reduced or elevated pressure. Of note are dehydroiodination reactions in which the compound of Formula I is distilled out of the reaction vessel as it is formed.

Alternatively, the dehydroiodination reaction may be conducted by contacting an aqueous solution of said basic substance with a solution of the trihydroiodoperfluoroalkane in one or more organic solvents of lower polarity such as an alkane (e.g., hexane, heptane, or octane), aromatic hydrocarbon (e.g., toluene), halogenated hydrocarbon (e.g., methylene chloride, chloroform, carbon tetrachloride, or perchloroethylene), or ether (e.g., diethyl ether, methyl tert-butyl ether, tetrahydrofuran, 2-methyl tetrahydrofuran, dioxane, dimethoxyethane, diglyme, or tetraglyme) in the presence of a phase transfer catalyst. Suitable phase transfer catalysts include quaternary ammonium halides (e.g., tetrabutylammonium bromide, tetrabutylammonium hydrosulfate, triethylbenzylammonium chloride, dodecyltrimethylammonium chloride, and tricaprylylmethylammonium chloride), quaternary phosphonium halides (e.g., triphenylmethylphosphonium bromide and tetraphenylphosphonium chloride), or cyclic polyether compounds known in the art as crown ethers (e.g., 18-crown-6 and 15-crown-5).

Alternatively, the dehydroiodination reaction may be conducted in the absence of solvent by adding the trihydroiodoperfluoroalkane to a solid or liquid basic substance.

Suitable reaction times for the dehydroiodination reactions are from about 15 minutes to about six hours or more depending on the solubility of the reactants. Typically the dehydroiodination reaction is rapid and requires about 30 minutes to about three hours for completion.

The compound of Formula I may be recovered from the dehydroiodination reaction mixture by phase separation after addition of water, by distillation, or by a combination thereof.

In another embodiment of the present invention, fluoroolefins comprise cyclic fluoroolefins (cyclo-[CX═CY(CZW)ₙ-] (Formula II), wherein X, Y, Z, and W are independently selected from H and F, and n is an integer from 2 to 5). In one embodiment the fluoroolefins of Formula II, have at least about 3 carbon atoms in the molecule. In another embodiment, the fluoroolefins of Formula II have at least about 4 carbon atoms in the molecule. In yet another embodiment, the fluoroolefins of Formula II have at least about 5 carbon atoms in the molecule. Representative cyclic fluoroolefins of Formula II are listed in Table 2.

TABLE 2

| Cyclic | | |
|---|---|---|
| fluoroolefins | Structure | Chemical name |
| HFO-C1316cc | cyclo-CF₂CF₂CF═CF— | 1,2,3,3,4,4- |
| | | hexafluorocyclobutene |
| HFO-C1334cc | cyclo-CF₂CF₂CH═CH— | 3,3,4,4- |
| | | tetrafluorocyclobutene |
| HFO-C1436 | Cyclo-CF₂CF₂CF₂CH═CH— | 3,3,4,4,5,5,- |
| | | hexafluorocyclopentene |
| HFO-C1418y | Cyclo-CF₂CF═CFCF₂CF₂— | 1,2,3,3,4,4,5,5- |
| | | octafluorocyclopentene |
| HFO-C151-10y | Cyclo- | 1,2,3,3,4,4,5,5,6,6- |
| | CF₂CF═CFCF₂CF₂CF₂— | decafluorocyclohexene |

The compositions of the present invention may comprise a single compound of Formula I or Formula II, for example, one of the compounds in Table 1 or Table 2, or may comprise a combination of compounds of Formula I or Formula II.

In another embodiment, fluoroolefins may comprise those compounds listed in Table 3.

TABLE 3

| Name | Structure | Chemical name |
|---|---|---|
| HFO-1225ye | CF₃CF═CHF | 1,2,3,3,3-pentafluoro-1-propene |
| HFO-1225zc | CF₃CH═CF₂ | 1,1,3,3,3-pentafluoro-1-propene |
| HFO-1225yc | CHF₂CF═CF₂ | 1,1,2,3,3-pentafluoro-1-propene |
| HFO-1234ye | CHF₂CF═CHF | 1,2,3,3-tetrafluoro-1-propene |
| HFO-1234yf | CF₃CF═CH₂ | 2,3,3,3-tetrafluoro-1-propene |
| HFO-1234ze | CF₃CH═CHF | 1,3,3,3-tetrafluoro-1-propene |
| HFO-1234yc | CH₂FCF═CF₂ | 1,1,2,3-tetrafluoro-1-propene |
| HFO-1234zc | CHF₂CH═CF₂ | 1,1,3,3-tetrafluoro-1-propene |
| HFO-1243yf | CHF₂CF═CH₂ | 2,3,3-trifluoro-1-propene |
| HFO-1243zf | CF₃CH═CH₂ | 3,3,3-trifluoro-1-propene |
| HFO-1243yc | CH₃CF═CF₂ | 1,1,2-trifluoro-1-propene |
| HFO-1243zc | CH₂FCH═CF₂ | 1,1,3-trifluoro-1-propene |
| HFO-1243ye | CH₂FCF═CHF | 1,2,3-trifluoro-1-propene |
| HFO-1243ze | CHF₂CH═CHF | 1,3,3-trifluoro-1-propene |
| HCFO-1233xf | CF₃CCl═CH₂ | 2-chloro-3,3,3-trifluoro-1-propene |
| HCFO-1233zd | CF₃CH═CHCl | 1-chloro-3,3,3-trifluoro-1-propene |
| HFO-1318my | CF₃CF═CFCF₃ | 1,1,1,2,3,4,4,4-octafluoro-2-butene |
| HFO-1318cy | CF₃CF₂CF═CF₂ | 1,1,2,3,3,4,4,4-octafluoro-1-butene |
| HFO-1327my | CF₃CF═CHCF₃ | 1,1,1,2,4,4,4-heptafluoro-2-butene |
| HFO-1327ye | CHF═CFCF₂CF₃ | 1,2,3,3,4,4,4-heptafluoro-1-butene |
| HFO-1327py | CHF₂CF═CFCF₃ | 1,1,1,2,3,4,4-heptafluoro-2-butene |
| HFO-1327et | (CF₃)₂C═CHF | 1,3,3,3-tetrafluoro-2- |
| | | (trifluoromethyl)-1-propene |
| HFO-1327cz | CF₂═CHCF₂CF₃ | 1,1,3,3,4,4,4-heptafluoro-1-butene |
| HFO-1327cye | CF₂═CFCHFCF₃ | 1,1,2,3,4,4,4-heptafluoro-1-butene |
| HFO-1327cyc | CF₂═CFCF₂CHF₂ | 1,1,2,3,3,4,4-heptafluoro-1-butene |
| HFO-1336yf | CF₃CF₂CF═CH₂ | 2,3,3,4,4,4-hexafluoro-1-butene |
| HFO-1336ze | CHF═CHCF₂CF₃ | 1,3,3,4,4,4-hexafluoro-1-butene |
| HFO-1336eye | CHF═CFCHFCF₃ | 1,2,3,4,4,4-hexafluoro-1-butene |
| HFO-1336eyc | CHF═CFCF₂CHF₂ | 1,2,3,3,4,4-hexafluoro-1-butene |
| HFO-1336pyy | CHF₂CF═CFCHF₂ | 1,1,2,3,4,4-hexafluoro-2-butene |
| HFO-1336qy | CH₂FCF═CFCF₃ | 1,1,1,2,3,4-hexafluoro-2-butene |
| HFO-1336pz | CHF₂CH═CFCF₃ | 1,1,1,2,4,4-hexafluoro-2-butene |
| HFO-1336mzy | CF₃CH═CFCHF₂ | 1,1,1,3,4,4-hexafluoro-2-butene |
| HFO-1336qc | CF₂═CFCF₂CH₂F | 1,1,2,3,3,4-hexafluoro-1-butene |
| HFO-1336pe | CF₂═CFCHFCHF₂ | 1,1,2,3,4,4-hexafluoro-1-butene |
| HFO-1336ft | CH₂═C(CF₃)₂ | 3,3,3-trifluoro-2-(trifluoromethyl)-1- |
| | | propene |
| HFO-1345qz | CH₂FCH═CFCF₃ | 1,1,1,2,4-pentafluoro-2-butene |
| HFO-1345mzy | CF₃CH═CFCH₂F | 1,1,1,3,4-pentafluoro-2-butene |
| HFO-1345fz | CF₃CF₂CH═CH₂ | 3,3,4,4,4-pentafluoro-1-butene |
| HFO-1345mzz | CHF₂CH═CHCF₃ | 1,1,1,4,4-pentafluoro-2-butene |
| HFO-1345sy | CH₃CF═CFCF₃ | 1,1,1,2,3-pentafluoro-2-butene |
| HFO-1345fyc | CH₂═CFCF₂CHF₂ | 2,3,3,4,4-pentafluoro-1-butene |
| HFO-1345pyz | CHF₂CF═CHCHF₂ | 1,1,2,4,4-pentafluoro-2-butene |
| HFO-1345cyc | CH₃CF₂CF═CF₂ | 1,1,2,3,3-pentafluoro-1-butene |
| HFO-1345pyy | CH₂FCF═CFCHF₂ | 1,1,2,3,4-pentafluoro-2-butene |
| HFO-1345eyc | CH₂FCF₂CF═CHF | 1,2,3,3,4-pentafluoro-1-butene |
| HFO-1345ctm | CF₂═C(CF₃)(CH₃) | 1,1,3,3,3-pentafluoro-2-methyl-1- |
| | | propene |
| HFO-1345ftp | CH₂═C(CHF₂)(CF₃) | 2-(difluoromethyl)-3,3,3-trifluoro-1- |
| | | propene |
| HFO-1345fye | CH₂═CFCHFCF₃ | 2,3,4,4,4-pentafluoro-1-butene |
| HFO-1345eyf | CHF═CFCH₂CF₃ | 1,2,4,4,4-pentafluoro-1-butene |
| HFO-1345eze | CHF═CHCHFCF₃ | 1,3,4,4,4-pentafluoro-1-butene |
| HFO-1345ezc | CHF═CHCF₂CHF₂ | 1,3,3,4,4-pentafluoro-1-butene |
| HFO-1345eye | CHF═CFCHFCHF₂ | 1,2,3,4,4-pentafluoro-1-butene |
| HFO-1354fzc | CH₂═CHCF₂CHF₂ | 3,3,4,4-tetrafluoro-1-butene |
| HFO-1354ctp | CF₂═C(CHF₂)(CH₃) | 1,1,3,3-tetrafluoro-2-methyl-1- |
| | | propene |
| HFO-1354etm | CHF═C(CF₃)(CH₃) | 1,3,3,3-tetrafluoro-2-methyl-1- |
| | | propene |
| HFO-1354tfp | CH₂═C(CHF₂)₂ | 2-(difluoromethyl)-3,3-difluoro-1- |
| | | propene |
| HFO-1354my | CF₃CF═CHCH₃ | 1,1,1,2-tetrafluoro-2-butene |
| HFO-1354mzy | CH₃CF═CHCF₃ | 1,1,1,3-tetrafluoro-2-butene |
| HFO-141-10myy | CF₃CF═CFCF₂CF₃ | 1,1,1,2,3,4,4,5,5,5-decafluoro-2- |
| | | pentene |
| HFO-141-10cy | CF₂═CFCF₂CF₂CF₃ | 1,1,2,3,3,4,4,5,5,5-decafluoro-1- |
| | | pentene |
| HFO-1429mzt | (CF₃)₂C═CHCF₃ | 1,1,1,4,4,4-hexafluoro-2- |
| | | (trifluoromethyl)-2-butene |
| HFO-1429myz | CF₃CF═CHCF₂CF₃ | 1,1,1,2,4,4,5,5,5-nonafluoro-2- |
| | | pentene |
| HFO-1429mzy | CF₃CH═CFCF₂CF₃ | 1,1,1,3,4,4,5,5,5-nonafluoro-2- |
| | | pentene |
| HFO-1429eyc | CHF═CFCF₂CF₂CF₃ | 1,2,3,3,4,4,5,5,5-nonafluoro-1- |
| | | pentene |
| HFO-1429czc | CF₂═CHCF₂CF₂CF₃ | 1,1,3,3,4,4,5,5,5-nonafluoro-1- |
| | | pentene |
| HFO-1429cycc | CF₂═CFCF₂CF₂CHF₂ | 1,1,2,3,3,4,4,5,5-nonafluoro-1- |
| | | pentene |
| HFO-1429pyy | CHF₂CF═CFCF₂CF₃ | 1,1,2,3,4,4,5,5,5-nonafluoro-2- |
| | | pentene |
| HFO-1429myyc | CF₃CF═CFCF₂CHF₂ | 1,1,1,2,3,4,4,5,5-nonafluoro-2- |
| | | pentene |
| HFO-1429myye | CF₃CF═CFCHFCF₃ | 1,1,1,2,3,4,5,5,5-nonafluoro-2- |
| | | pentene |
| HFO-1429eyym | CHF═CFCF(CF₃)₂ | 1,2,3,4,4,4-hexafluoro-3- |
| | | (trifluoromethyl)-1-butene |
| HFO-1429cyzm | CF₂═CFCH(CF₃)₂ | 1,1,2,4,4,4-hexafluoro-3- |
| | | (trifluoromethyl)-1-butene |
| HFO-1429mzt | CF₃CH═C(CF₃)₂ | 1,1,1,4,4,4-hexafluoro-2- |
| | | (trifluoromethyl)-2-butene |
| HFO-1429czym | CF₂═CHCF(CF₃)₂ | 1,1,3,4,4,4-hexafluoro-3- |
| | | (trifluoromethyl)-1-butene |
| HFO-1438fy | CH₂═CFCF₂CF₂CF₃ | 2,3,3,4,4,5,5,5-octafluoro-1- |
| | | pentene |
| HFO-1438eycc | CHF═CFCF₂CF₂CHF₂ | 1,2,3,3,4,4,5,5-octafluoro-1- |
| | | pentene |
| HFO-1438ftmc | CH₂═C(CF₃)CF₂CF₃ | 3,3,4,4,4-pentafluoro-2- |
| | | (trifluoromethyl)-1-butene |
| HFO-1438czzm | CF₂═CHCH(CF₃)₂ | 1,1,4,4,4-pentafluoro-3- |
| | | (trifluoromethyl)-1-butene |
| HFO-1438ezym | CHF═CHCF(CF₃)₂ | 1,3,4,4,4-pentafluoro-3- |
| | | (trifluoromethyl)-1-butene |
| HFO-1438ctmf | CF₂═C(CF₃)CH₂CF₃ | 1,1,4,4,4-pentafluoro-2- |
| | | (trifluoromethyl)-1-butene |
| HFO-1447fzy | (CF₃)₂CFCH═CH₂ | 3,4,4,4-tetrafluoro-3- |
| | | (trifluoromethyl)-1-butene |
| HFO-1447fz | CF₃CF₂CF₂CH═CH₂ | 3,3,4,4,5,5,5-heptafluoro-1-pentene |
| HFO-1447fycc | CH₂═CFCF₂CF₂CHF₂ | 2,3,3,4,4,5,5-heptafluoro-1-pentene |
| HFO-1447czcf | CF₂═CHCF₂CH₂CF₃ | 1,1,3,3,5,5,5-heptafluoro-1-pentene |
| HFO-1447mytm | CF₃CF═C(CF₃)(CH₃) | 1,1,1,2,4,4,4-heptafluoro-3-methyl- |
| | | 2-butene |
| HFO-1447fyz | CH₂═CFCH(CF₃)₂ | 2,4,4,4-tetrafluoro-3- |
| | | (trifluoromethyl)-1-butene |
| HFO-1447ezz | CHF═CHCH(CF₃)₂ | 1,4,4,4-tetrafluoro-3- |
| | | (trifluoromethyl)-1-butene |
| HFO-1447qzt | CH₂FCH═C(CF₃)₂ | 1,4,4,4-tetrafluoro-2- |
| | | (trifluoromethyl)-2-butene |
| HFO-1447syt | CH₃CF═C(CF₃)₂ | 2,4,4,4-tetrafluoro-2- |
| | | (trifluoromethyl)-2-butene |
| HFO-1456szt | (CF₃)₂C═CHCH₃ | 3-(trifluoromethyl)-4,4,4-trifluoro-2- |
| | | butene |
| HFO-1456szy | CF₃CF₂CF═CHCH₃ | 3,4,4,5,5,5-hexafluoro-2-pentene |
| HFO-1456mstz | CF₃C(CH₃)═CHCF₃ | 1,1,1,4,4,4-hexafluoro-2-methyl-2- |
| | | butene |
| HFO-1456fzce | CH₂═CHCF₂CHFCF₃ | 3,3,4,5,5,5-hexafluoro-1-pentene |
| HFO-1456ftmf | CH₂═C(CF₃)CH₂CF₃ | 4,4,4-trifluoro-2-(trifluoromethyl)-1- |
| | | butene |
| HFO-151-12c | CF₃(CF₂)₃CF═CF₂ | 1,1,2,3,3,4,4,5,5,6,6,6- |
| | | dodecafluoro-1-hexene (or |
| | | perfluoro-1-hexene) |
| HFO-151-12mcy | CF₃CF₂CF═CFCF₂CF₃ | 1,1,1,2,2,3,4,5,5,6,6,6- |
| | | dodecafluoro-3-hexene (or |
| | | perfluoro-3-hexene) |
| HFO-151-12mmtt | (CF₃)₂C═C(CF₃)₂ | 1,1,1,4,4,4-hexafluoro-2,3- |
| | | bis(trifluoromethyl)-2-butene |
| HFO-151-12mmzz | (CF₃)₂CFCF═CFCF₃ | 1,1,1,2,3,4,5,5,5-nonafluoro-4- |
| | | (trifluoromethyl)-2-pentene |
| HFO-152-11mmtz | (CF₃)₂C═CHC₂F₅ | 1,1,1,4,4,5,5,5-octafluoro-2- |
| | | (trifluoromethyl)-2-pentene |
| HFO-152- | (CF₃)₂CFCF═CHCF₃ | 1,1,1,3,4,5,5,5-octafluoro-4- |
| 11mmyyz | | (trifluoromethyl)-2-pentene |
| PFBE | CF₃CF₂CF₂CF₂CH═CH₂ | 3,3,4,4,5,5,6,6,6-nonafluoro-1- |
| (or HFO-1549fz) | | hexene (or perfluorobutylethylene) |
| HFO-1549fztmm | CH₂═CHC(CF₃)₃ | 4,4,4-trifluoro-3,3- |
| | | bis(trifluoromethyl)-1-butene |
| HFO-1549mmtts | (CF₃)₂C═C(CH₃)(CF₃) | 1,1,1,4,4,4-hexafluoro-3-methyl-2- |
| | | (trifluoromethyl)-2-butene |
| HFO-1549fycz | CH₂═CFCF₂CH(CF₃)₂ | 2,3,3,5,5,5-hexafluoro-4- |
| | | (trifluoromethyl)-1-pentene |
| HFO-1549myts | CF₃CF═C(CH₃)CF₂CF₃ | 1,1,1,2,4,4,5,5,5-nonafluoro-3- |
| | | methyl-2-pentene |
| HFO-1549mzzz | CF₃CH═CHCH(CF₃)₂ | 1,1,1,5,5,5-hexafluoro-4- |
| | | (trifluoromethyl)-2-pentene |
| HFO-1558szy | CF₃CF₂CF₂CF═CHCH₃ | 3,4,4,5,5,6,6,6-octafluoro-2-hexene |
| HFO-1558fzccc | CH₂═CHCF₂CF₂CF₂CHF₂ | 3,3,4,4,5,5,6,6-octafluoro-2-hexene |
| HFO-1558mmtzc | (CF₃)₂C═CHCF₂CH₃ | 1,1,1,4,4-pentafluoro-2- |
| | | (trifluoromethyl)-2-pentene |
| HFO-1558ftmf | CH₂═C(CF₃)CH₂C₂F₅ | 4,4,5,5,5-pentafluoro-2- |
| | | (trifluoromethyl)-1-pentene |
| HFO-1567fts | CF₃CF₂CF₂C(CH₃)═CH₂ | 3,3,4,4,5,5,5-heptafluoro-2-methyl- |
| | | 1-pentene |
| HFO-1567szz | CF₃CF₂CF₂CH═CHCH₃ | 4,4,5,5,6,6,6-heptafluoro-2-hexene |
| HFO-1567fzfc | CH₂═CHCH₂CF₂C₂F₅ | 4,4,5,5,6,6,6-heptafluoro-1-hexene |
| HFO-1567sfyy | CF₃CF₂CF═CFC₂H₅ | 1,1,1,2,2,3,4-heptafluoro-3-hexene |
| HFO-1567fzfy | CH₂═CHCH₂CF(CF₃)₂ | 4,5,5,5-tetrafluoro-4- |
| | | (trifluoromethyl)-1-pentene |
| HFO-1567myzzm | CF₃CF═CHCH(CF₃)(CH₃) | 1,1,1,2,5,5,5-heptafluoro-4-methyl- |
| | | 2-pentene |
| HFO-1567mmtyf | (CF₃)₂C═CFC₂H₅ | 1,1,1,3-tetrafluoro-2- |
| | | (trifluoromethyl)-2-pentene |
| HFO-161-14myy | CF₃CF═CFCF₂CF₂C₂F₅ | 1,1,1,2,3,4,4,5,5,6,6,7,7,7- |
| | | tetradecafluoro-2-heptene |
| HFO-161-14mcyy | CF₃CF₂CF═CFCF₂C₂F₅ | 1,1,1,2,2,3,4,5,5,6,6,7,7,7- |
| | | tetradecafluoro-2-heptene |
| HFO-162-13mzy | CF₃CH═CFCF₂CF₂C₂F₅ | 1,1,1,3,4,4,5,5,6,6,7,7,7- |
| | | tridecafluoro-2-heptene |
| HFC162-13myz | CF₃CF═CHCF₂CF₂C₂F₅ | 1,1,1,2,4,4,5,5,6,6,7,7,7- |
| | | tridecafluoro-2-heptene |
| HFO-162-13mczy | CF₃CF₂CH═CFCF₂C₂F₅ | 1,1,1,2,2,4,5,5,6,6,7,7,7- |
| | | tridecafluoro-3-heptene |
| HFO-162-13mcyz | CF₃CF₂CF═CHCF₂C₂F₅ | 1,1,1,2,2,3,5,5,6,6,7,7,7- |
| | | tridecafluoro-3-heptene |
| PEVE | CF₂═CFOCF₂CF₃ | pentafluoroethyl trifluorovinyl ether |
| PMVE | CF₂═CFOCF₃ | trifluoromethyl trifluorovinyl ether |

The compounds listed in Table 2 and Table 3 are available commercially or may be prepared by processes known in the art or as described herein.

1,1,1,4,4-pentafluoro-2-butene may be prepared from 1,1,1,2,4,4-hexafluorobutane (CHF₂CH₂CHFCF₃) by dehydrofluorination over solid KOH in the vapor phase at room temperature. The synthesis of 1,1,1,2,4,4-hexafluorobutane is described in U.S. Pat. No. 6,066,768. 1,1,1,4,4,4-hexafluoro-2-butene may be prepared from 1,1,1,4,4,4-hexafluoro-2-iodobutane (CF₃CHICH₂CF₃) by reaction with KOH using a phase transfer catalyst at about 60° C. The synthesis of 1,1,1,4,4,4-hexafluoro-2-iodobutane may be carried out by reaction of perfluoromethyl iodide (CF₃I) and 3,3,3-trifluoropropene (CF₃CH═CH₂) at about 200° C. under autogenous pressure for about 8 hours.

3,4,4,5,5,5-hexafluoro-2-pentene may be prepared by dehydrofluorination of 1,1,1,2,2,3,3-heptafluoropentane (CF₃CF₂CF₂CH₂CH₃) using solid KOH or over a carbon catalyst at 200-300° C. 1,1,1,2,2,3,3-heptafluoropentane may be prepared by hydrogenation of 3,3,4,4,5,5,5-heptafluoro-1-pentene (CF₃CF₂CF₂CH═CH₂).

1,1,1,2,3,4-hexafluoro-2-butene may be prepared by dehydrofluorination of 1,1,1,2,3,3,4-heptafluorobutane (CH₂FCF₂CHFCF₃) using solid KOH.

1,1,1,2,4,4-hexafluoro-2-butene may be prepared by dehydrofluorination of 1,1,1,2,2,4,4-heptafluorobutane (CHF₂CH₂CF₂CF₃) using solid KOH.

1,1,1,3,4,4-hexafluoro2-butene may be prepared by dehydrofluorination of 1,1,1,3,3,4,4-heptafluorobutane (CF₃CH₂CF₂CHF₂) using solid KOH.

1,1,1,2,4-pentafluoro-2-butene may be prepared by dehydrofluorination of 1,1,1,2,2,3-hexafluorobutane (CH₂FCH₂CF₂CF₃) using solid KOH.

1,1,1,3,4-pentafluoro-2-butene may be prepared by dehydrofluorination of 1,1,1,3,3,4-hexafluorobutane (CF₃CH₂CF₂CH₂F) using solid KOH.

1,1,1,3-tetrafluoro-2-butene may be prepared by reacting 1,1,1,3,3-pentafluorobutane (CF₃CH₂CF₂CH₃) with aqueous KOH at 120° C.

1,1,1,4,4,5,5,5-octafluoro-2-pentene may be prepared from (CF₃CHICH₂CF₂CF₃) by reaction with KOH using a phase transfer catalyst at about 60° C. The synthesis of 4-iodo-1,1,1,2,2,5,5,5-octafluoropentane may be carried out by reaction of perfluoroethyliodide (CF₃CF₂I) and 3,3,3-trifluoropropene at about 200° C. under autogenous pressure for about 8 hours.

1,1,1,2,2,5,5,6,6,6-decafluoro-3-hexene may be prepared from 1,1,1,2,2,5,5,6,6,6-decafluoro-3-iodohexane (CF₃CF₂CHICH₂CF₂CF₃) by reaction with KOH using a phase transfer catalyst at about 60° C. The synthesis of 1,1,1,2,2,5,5,6,6,6-decafluoro-3-iodohexane may be carried out by reaction of perfluoroethyliodide (CF₃CF₂I) and 3,3,4,4,4-pentafluoro-1-butene (CF₃CF₂CH═CH₂) at about 200° C. under autogenous pressure for about 8 hours.

1,1,1,4,5,5,5-heptafluoro-4-(trifluoromethyl)-2-pentene may be prepared by the dehydrofluorination of 1,1,1,2,5,5,5-heptafluoro-4-iodo-2-(trifluoromethyl)-pentane (CF₃CHICH₂CF(CF₃)₂) with KOH in isopropanol. CF₃CHICH₂CF(CF₃)₂ is made from reaction of (CF₃)₂CFI with CF₃CH═CH₂ at high temperature, such as about 200° C.

1,1,1,4,4,5,5,6,6,6-decafluoro-2-hexene may be prepared by the reaction of 1,1,1,4,4,4-hexafluoro-2-butene (CF₃CH═CHCF₃) with tetrafluoroethylene (CF₂═CF₂) and antimony pentafluoride (SbF₅).

2,3,3,4,4-pentafluoro-1-butene may be prepared by dehydrofluorination of 1,1,2,2,3,3-hexafluorobutane over fluorided alumina at elevated temperature.

2,3,3,4,4,5,5,5-ocatafluoro-1-pentene may be prepared by dehydrofluorination of 2,2,3,3,4,4,5,5,5-nonafluoropentane over solid KOH.

1,2,3,3,4,4,5,5-octafluoro-1-pentene may be prepared by dehydrofluorination of 2,2,3,3,4,4,5,5,5-nonafluoropentane over fluorided alumina at elevated temperature.

Many of the compounds of Formula I, Formula II, Table 1, Table 2 and Table 3 exist as different configurational isomers or stereoisomers. When the specific isomer is not designated, the present invention is intended to include all single configurational isomers, single stereoisomers, or any combination thereof. For instance, F11E is meant to represent the E-isomer, Z-isomer, or any combination or mixture of both isomers in any ratio. As another example, HFO-1225ye is meant to represent the E-isomer, Z-isomer, or any combination or mixture of both isomers in any ratio.

In one embodiment, disclosed is a composition comprising at least one fluoroolefin selected from the group consisting of HFO-1234yf, E-HFO-1234ze (trans), HFO-1243zf, F12E (E- or Z-isomer), HFO-1233xd, HFO-1233zf, E-F11E, Z-F11E, F22E (E- or Z-isomer), F24E (E- or Z-isomer), F33E (E- or Z-isomer), HFO-1429myz, HFO-1429mzy, HFO-1447fzy (PFBE), HFO-162-13mczy, HFO-162-13mcyz, and mixtures thereof; and an effective amount of at least one ionic liquid.

In one embodiment, the compositions comprise at least about 1 weight percent of at least one fluoroolefin. In another embodiment, the compositions comprise from about 1 weight percent to about 99 weight percent of at least one ionic liquid and from about 99 weight percent to about 1 weight percent at least one fluoroolefin. In another embodiment, the compositions comprise from about 20 weight percent to about 99 weight percent of at least one ionic liquid and from about 80 weight percent to about 1 weight percent at least one fluoroolefin. In another embodiment, the compositions comprise from about 20 weight percent to about 60 weight percent of at least one ionic liquid and from about 80 weight percent to about 40 weight percent at least one fluoroolefin. In yet another embodiment, the compositions comprise from about 20 weight percent to about 50 weight percent of at least one ionic liquid and from about 80 weight percent to about 50 weight percent at least one fluoroolefin.

In certain embodiments, the disclosed compositions may further comprise additional refrigerants selected from the group consisting of hydrofluorocarbons, fluoroethers, hydrochlorofluorocarbons, chlorofluorocarbons, perfluorocarbons, hydrocarbons, CF₃I, NH₃, CO₂, and mixtures thereof, meaning mixtures of any of the foregoing compounds. In one particular embodiment, the composition of the present invention may comprise at least one ionic liquid, at least one fluoroolefin, and at least one hydrofluorocarbon.

Hydrofluorocarbons comprise at least one saturated compound containing carbon, hydrogen, and fluorine. Of particular utility are hydrofluorocarbons having 1-7 carbon atoms and having a normal boiling point of from about −90° C. to about 80° C. Hydrofluorocarbons are commercial products available from a number of sources or may be prepared by methods known in the art. Representative hydrofluorocarbon compounds include but are not limited to fluoromethane (CH₃F, HFC-41), difluoromethane (CH₂F₂, HFC-32), trifluoromethane (CHF₃, HFC-23), pentafluoroethane (CF₃CHF₂, HFC-125), 1,1,2,2-tetrafluoroethane (CHF₂CHF₂, HFC-134), 1,1,1,2-tetrafluoroethane (CF₃CH₂F, HFC-134a), 1,1,1-trifluoroethane (CF₃CH₃, HFC-143a), 1,1-difluoroethane (CHF₂CH₃, HFC-152a), fluoroethane (CH₃CH₂F, HFC-161), 1,1,1,2,2,3,3-heptafluoropropane (CF₃CF₂CHF₂, HFC-227ca), 1,1,1,2,3,3,3-heptafluoropropane (CF₃CHFCF₃, HFC-227ea), 1,1,2,2,3,3,-hexafluoropropane (CHF₂CF₂CHF₂, HFC-236ca), 1,1,1,2,2,3-hexafluoropropane (CF₃CF₃CH₂F, HFC-236cb), 1,1,1,2,3,3-hexafluoropropane (CF₃CHFCHF₂, HFC-236ea), 1,1,1,3,3,3-hexafluoropropane (CF₃CH₂CF₃, HFC-236fa), 1,1,2,2,3-pentafluoropropane (CHF₂CF₂CH₂F, HFC-245ca), 1,1,1,2,2-pentafluoropropane (CF₃CF₂CH₃, HFC-245cb), 1,1,2,3,3-pentafluoropropane (CHF₂CHFCHF₂, HFC-245ea), 1,1,1,2,3-pentafluoropropane (CF₃CHFCH₂F, HFC-245eb), 1,1,1,3,3-pentafluoropropane (CF₃CH₂CHF₂, HFC-245fa), 1,2,2,3-tetrafluoropropane (CH₂FCF₂CH₂F, HFC-254ca), 1,1,2,2-tetrafluoropropane (CHF₂CF₂CH₃, HFC-254cb), 1,1,2,3-tetrafluoropropane (CHF₂CHFCH₂F, HFC-254ea), 1,1,1,2-tetrafluoropropane (CF₃CHFCH₃, HFC-254eb), 1,1,3,3-tetrafluoropropane (CHF₂CH₂CHF₂, HFC-254fa), 1,1,1,3-tetrafluoropropane (CF₃CH₂CH₂F, HFC-254fb), 1,1,1-trifluoropropane (CF₃CH₂CH₃, HFC-263fb), 2,2-difluoropropane (CH₃CF₂CH₃, HFC-272ca), 1,2-difluoropropane (CH₂FCHFCH₃, HFC-272ea), 1,3-difluoropropane (CH₂FCH₂CH₂F, HFC-272fa), 1,1-difluoropropane (CHF₂CH₂CH₃, HFC-272fb), 2-fluoropropane (CH₃CHFCH₃, HFC-281ea), 1-fluoropropane (CH₂FCH₂CH₃, HFC-281fa), 1,1,2,2,3,3,4,4-octafluorobutane (CHF₂CF₂CF₂CHF₂, HFC-338 pcc), 1,1,1,2,2,4,4,4-octafluorobutane (CF₃CH₂CF₂CF₃, HFC-338mf), 1,1,1,3,3-pentafluorobutane (CF₃CH₂CHF₂, HFC-365mfc), 1,1,1,2,3,4,4,5,5,5-decafluoropentane (CF₃CHFCHFCF₂CF₃, HFC-43-10mee), and 1,1,1,2,2,3,4,5,5,6,6,7,7,7-tetradecafluoroheptane (CF₃CF₂CHFCHFCF₂CF₂CF₃, HFC-63-14mee).

In some embodiments, the disclosed compositions may further comprise fluoroethers. Fluoroethers comprise at least one compound having carbon, fluorine, oxygen and optionally hydrogen, chlorine, bromine or iodine. Fluoroethers are commercially available or may be produced by methods known in the art. Representative fluoroethers include but are not limited to nonafluoromethoxybutane (C₄F₉OCH₃, any or all possible isomers or mixtures thereof); nonafluoroethoxybutane (C₄F₉OC₂H₅, any or all possible isomers or mixtures thereof); 2-difluoromethoxy-1,1,1,2-tetrafluoroethane (HFOC-236eaEβγ, or CHF₂OCHFCF₃); 1,1-difluoro-2-methoxyethane (HFOC-272fbEβγ, CH₃OCH₂CHF₂); 1,1,1,3,3,3-hexafluoro-2-(fluoromethoxy)propane (HFOC-347 mmzEβγ, or CH₂FOCH(CF₃)₂); 1,1,1,3,3,3-hexafluoro-2-methoxypropane (HFOC-356 mmzEβγ, or CH₃OCH(CH₃)₂); 1,1,1,2,2-pentafluoro-3-methoxypropane (HFOC-365mcEγδ, or CF₃CF₂CH₂OCH₃); 2-ethoxy-1,1,1,2,3,3,3-heptafluoropropane (HFOC-467 mmyEβγ, or CH₃CH₂OCF(CF₃)₂; and mixtures thereof.

In some embodiments, the disclosed compositions may further comprise hydrochlorofluorocarbons. Hydrochlorofluorocarbons (HCFCs) comprise compounds having carbon, hydrogen, chlorine and fluorine in the molecule. In one embodiment, HCFCs comprise compounds having from 1 to 3 carbons per molecule. Representative HCFCs include, chlorodifluoromethane (HCFC-22, CHF₂Cl), 2,2-dichloro-1,1,1-trifluoroethane (HCFC-123, CHCl₂CF₃), 2-chloro-1,1,1,2-tetrafluoroethane (HCFC-124, CHFClCF₃), and mixtures thereof.

In some embodiments, the disclosed compositions may further comprise chlorofluorocarbons (CFCs). Chlorofluorocarbons comprise compounds having carbon, chlorine and fluorine in the molecule. In one embodiment, CFCs comprise compounds having from 1-3 carbon atoms. Representative CFCs include fluorotrichloromethane (CFC-11, CFCl₃), dichlorodifluoromethane (CFC-12, CF₂Cl₂) 1,2-dichloro-1,1,2,2-difluoroethane (CFC-114, CF₂ClCF₂Cl), 2,2-dichloro-1,1,1,2-tetrafluoroethane (CFC-114a, CFCl₂CF₃), 1,1,2-trichloro-1,2,2-trifluoroethane (CFC-113, CFCl₂CF₂Cl), and mixtures thereof.

In some embodiments, the disclosed compositions may further comprise perfluorocarbons (sometimes referred to simply as fluorocarbons). Perfluorocarbons (PFCs or FCs) comprise compounds having carbon and fluorine only in the molecule. In one embodiment, PFCs comprise compounds having from 1-4 carbon atoms. Representative PFCs include tetrafluoromethane (PFC-14, CF₄), hexafluoroethane (PFC-116, CF₃CF₃), tetrafluoroethylene (TFE, CF₂═CF₂), octafluoropropane (PFC-218, CF₃CF₂CF₃), octafluorocyclobutane (PF-C318, cyclo-CF₂CF₂CF₂CF₂—), and mixtures thereof.

In some embodiments, the disclosed compositions may further comprise at least one hydrocarbon. Hydrocarbons are compounds having only carbon and hydrogen. Of particular utility are compounds having 3-7 carbon atoms. Hydrocarbons are commercially available through numerous chemical suppliers. Representative hydrocarbons include but are not limited to propane, n-butane, isobutane, cyclobutane, n-pentane, 2-methylbutane, 2,2-dimethylpropane, cyclopentane, n-hexane, 2-methylpentane, 2,2-dimethylbutane, 2,3-dimethylbutane, 3-methylpentane, cyclohexane, n-heptane, cycloheptane, and mixtures thereof. In some embodiments, the disclosed compositions may comprise hydrocarbons containing heteroatoms, such as dimethylether (DME, CH₃OCH₃). DME is commercially available.

In some embodiments, the disclosed compositions may further comprise carbon dioxide (CO₂), which is commercially available from various sources or may be prepared by methods known in the art.

In some embodiments, the disclosed compositions may further comprise ammonia (NH₃), which is commercially available from various sources or may be prepared by methods known in the art.

In some embodiments, the disclosed compositions may further comprise iodotrifluoromethane (CF₃I), which is commercially available from various sources or may be prepared by methods known in the art.

In some embodiment, the compositions may comprise azeotrope or near-azeotrope compositions comprising a fluoroolefin and one of the other compounds as described previously herein selected from hydrofluorocarbons, hydrofluorocarbon ethers, hydrocarbons, CO₂, NH₃, and CF₃I.

As used herein, an azeotropic composition comprises a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a heat transfer system during operation, which may reduce efficiency of the system. Additionally, an azeotropic composition will not fractionate upon leakage from a heat transfer system.

As used herein, a near-azeotropic composition (also commonly referred to as an “azeotrope-like composition”) comprises a substantially constant boiling liquid admixture of two or more substances that behaves similarly to a single substance. One way to characterize a near-azeotropic composition is that the vapor produced by partial evaporation or distillation of the liquid has substantially the same composition as the liquid from which it was evaporated or distilled, that is, the admixture distills/refluxes without substantial composition change. Another way to characterize a near-azeotropic composition is that the bubble point vapor pressure and the dew point vapor pressure of the composition at a particular temperature are substantially the same. As used herein, a composition is near-azeotropic if, after 50 weight percent of the composition is removed, such as by evaporation or boiling off, the difference in vapor pressure between the original composition and the composition remaining after 50 weight percent of the original composition has been removed is less than about 10 percent.

In another embodiment, disclosed are compositions comprising at least one ionic liquid and various salts including LiBr. Mixtures of ionic liquids or mixtures of ionic liquids and salts may be used to achieve proper absorption, transport or other properties.

In another embodiment, the disclosed compositions may further comprise additives, including lubricants, corrosion inhibitors, crystallization inhibitors, stabilizers, solubilizers, dyes, viscosity modifiers, wetting agents, defoaming agents and surfactants, and mixtures thereof.

### Methods of Use

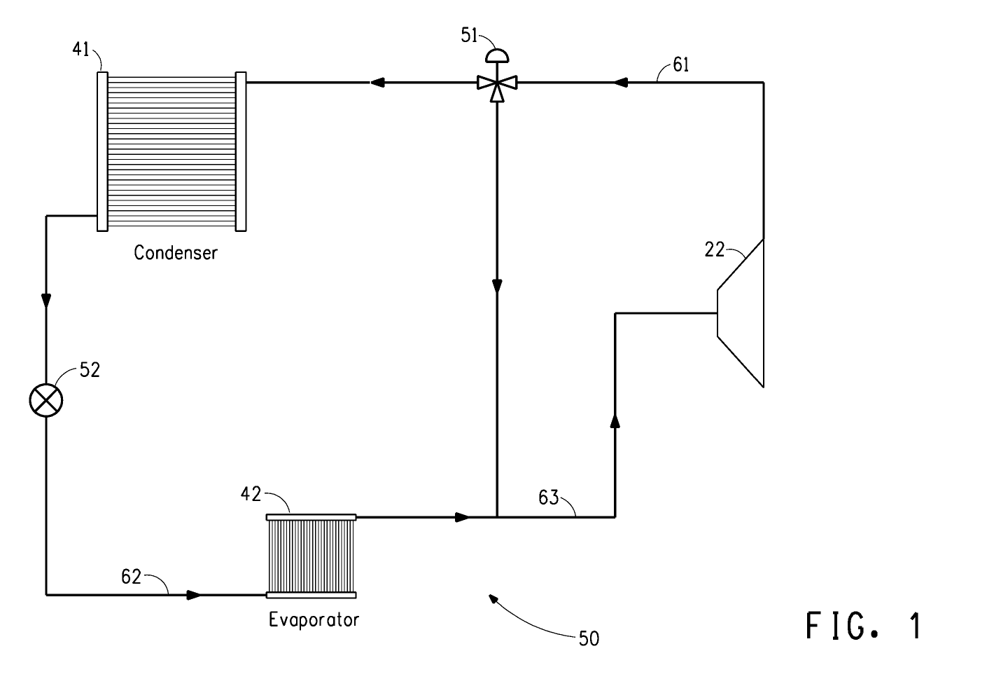

A typical vapor compression heat transfer system is shown generally at 50 in FIG. 1. With reference to FIG. 1, the system includes a compressor 22 having an inlet and an outlet. A gaseous refrigerant composition, flows from the outlet of an evaporator 42, having an inlet and an outlet, through a connecting line 63 to the inlet of the compressor, where the gaseous refrigerant is compressed to a higher pressure. The compressed, gaseous refrigerant composition from the compressor flows through the compressor outlet and through a connecting line 61 to a condenser 41. A pressure regulating valve 51 in connecting line 61 may be used. This valve allows recycle of the refrigerant flow back to the compressor via a connecting line 63, thereby providing the ability to control the pressure of the refrigerant composition reaching the condenser 41 and if necessary to prevent compressor surge. The compressed gaseous refrigerant composition is condensed in the condenser, thus giving off heat, and is converted to a liquid. The outlet of the condenser is connected to the inlet of an expander 52. The liquid refrigerant composition flows through expander 52 and expands. The expander 52 may be an expansion valve, a capillary tube or an orifice tube, or any other device where the heat transfer composition may undergo an abrupt reduction in pressure. The outlet of the expander is connected via a connecting line 62 to an evaporator 42, which is located in the vicinity of a body to be cooled. The liquid refrigerant composition boils in the evaporator at a low temperature to form a low pressure gas and thus produces cooling. The outlet of the evaporator is connected to the inlet of the compressor. The low-pressure refrigerant gas from the evaporator enters the compressor, where the gas is compressed to raise its pressure and temperature, and the cycle repeats.

In one embodiment, disclosed herein are refrigerant and absorbent compositions that may be useful for a wide range of absorption cooling applications spanning from low temperature refrigeration to comfort air conditioning.

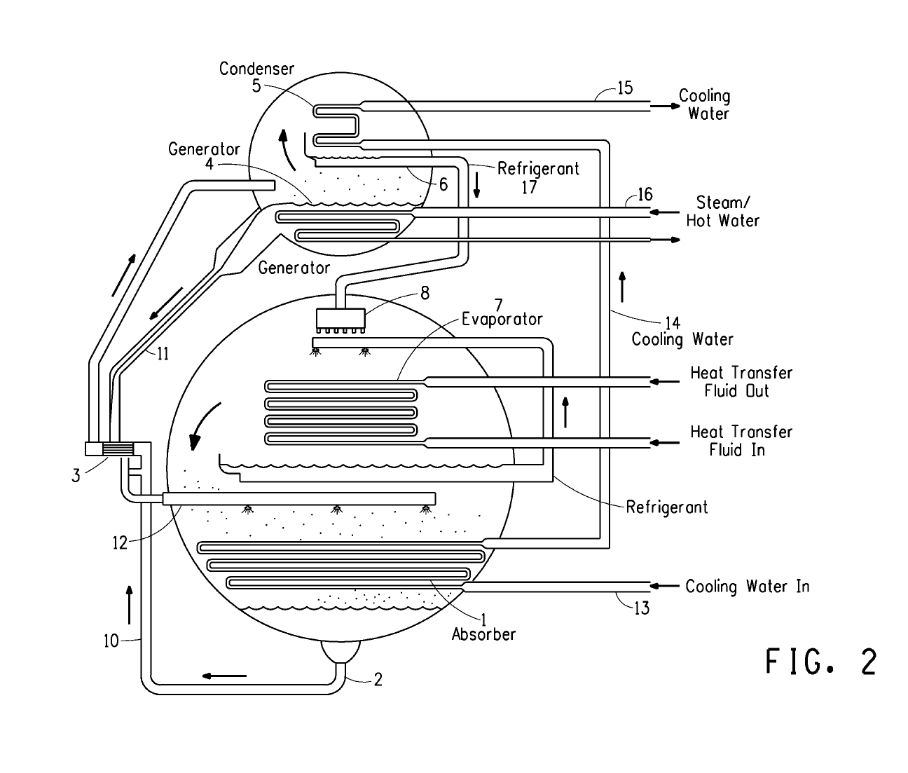

The working fluid pair compositions are useful in the execution of an absorption cycle. A schematic diagram for one embodiment, of a simple absorption cooling system is shown in FIG. 2. The system is composed of a condenser and an evaporator with an expansion device similar to equipment used in an ordinary vapor compression cycle as described above, but an absorber-generator solution circuit replaces the compressor. The absorber-generator solution circuit maybe composed of an absorber, a generator, a heat exchanger, a pressure control device (or expansion device) and a pump for circulating the solution. It is the strong affinity of the absorbent/working fluid pair for each other that makes the system work.

In a typical absorption cycle system, cooling is accomplished by absorbing and then releasing water vapor into and out of a lithium bromide (LiBr) solution. These absorption chillers operate at a partial vacuum (about 1/100^{th} of normal atmospheric pressure) to cause water to vaporize at a cold enough temperature (about 40° F.) to produce chilled water at about 44° F. The compositions disclosed herein may be used in similar systems either at vacuum or above atmospheric pressure, depending upon the physical properties of the refrigerant and absorbent being used. For low boiling fluoroolefin refrigerants, the pressure will be above atmospheric and still allow the system to produce cooling. Referring to FIG. 2, an absorption cycle can be described. The high refrigerant absorbent/refrigerant solution collects in the bottom of an absorber 1. A pump 2 is used to move the high refrigerant absorbent/refrigerant solution via line 10 through a heat exchanger 3 (e.g., shell and tube type) for pre-heating (the low-refrigerant absorbent/refrigerant solution from the generator provides the heat as will be described later herein). After exiting the heat exchanger, the high refrigerant absorbent/refrigerant solution moves into the generator 4. Within the generator is a bundle of tubes which carry steam, hot water, or combustion gases via line 16. The steam or hot water transfers heat into the high refrigerant absorbent/refrigerant solution. The heat causes the absorbent/refrigerant solution to release refrigerant vapor into a condenser 5 leaving a low refrigerant absorbent/refrigerant solution behind. The refrigerant is now a high pressure vapor. In one embodiment, there is only trace refrigerant left in solution in the low refrigerant absorbent/refrigerant solution. In another embodiment, some amount of refrigerant remains in the absorbent/refrigerant solution, said amount ranging from less than 1 weight percent to about 20 weight percent. In any of these embodiments, the amount of refrigerant is lower than in the high refrigerant absorbent/refrigerant solution that left the absorber. The exact amount of refrigerant remaining in the low refrigerant absorbent/refrigerant solution will depend on many factors including the relative solubility or affinity of the refrigerant in the absorbent. The low refrigerant absorbent/refrigerant solution moves via line 11 into the heat exchanger 3 where it is cooled by the high refrigerant absorbent/refrigerant solution being pumped out of the absorber. The low refrigerant absorbent/refrigerant solution moves from the heat exchanger to the absorber via line 12 and collects in the bottom of the absorber where it started the cycle.

In the condenser 5, cooling water is moving through the tubes and the refrigerant vapor condenses to form refrigerant liquid on the outside of the tubes that collects in a trough 6 at the bottom of the condenser. The refrigerant liquid moves from the condenser trough via line 17 to the evaporator 7 through an expansion device 8 that partially evaporates the refrigerant liquid. The partially evaporated refrigerant liquid contacts the tubes of the evaporator which have water or some other heat transfer fluid flowing therethrough. The heat transfer fluid is cooled as the liquid refrigerant is evaporated forming refrigerant vapor. The cooled heat transfer fluid is circulated back to a body to be cooled, such as a building, thus providing the cooling effect as desired for instance for air conditioning. The refrigerant vapor migrates to the absorber from the evaporator. The high affinity of the absorbent for the refrigerant causes the refrigerant to be dissolved into the absorbent/refrigerant solution. The absorption of the refrigerant into the absorbent also generates heat (heat of absorption). Cooling water moves through the tube bundles of the absorber to remove this heat of absorption from the system. The solution collecting at the bottom of the absorber is again a high refrigerant absorbent/refrigerant solution that will begin the cycle again.

Cooling water is used in both the absorber and condenser as described above. The cooling water will flow into the system at the absorber at 13, wherein it warms slightly due to the heat of solution of the refrigerant dissolving into the absorbent. From the absorber, the cooling water will move via line 14 to the condenser tube bundle wherein it will provide the cooling to condense the refrigerant vapor to refrigerant liquid. The cooling water is thus heated somewhat again and from the condenser flows via line 15 to a cooling tower or other device intended to release the heat picked up in the system to the atmosphere and provide cooled water again to the system.

The hot water, steam, or combustion gasses supplied to the generator in order to release refrigerant vapor from the absorbent/refrigerant solution may be supplied by any number of sources, including water heated with waste heat from a combustion engine (combustion gases) and solar heated water, among others.

In one embodiment, disclosed herein is a process for producing cooling comprising forming a refrigerant/absorbent mixture, heating said mixture to release refrigerant vapor, condensing said refrigerant to form liquid refrigerant, evaporating said liquid refrigerant in the vicinity of a heat transfer fluid, transferring said heat transfer fluid to the vicinity of a body to be cooled, and reforming the absorbent/refrigerant solution.

A body to be cooled may be any space, location, object or body which it is desirable to cool, including the interior spaces of buildings requiring air conditioning, and refrigerator or freezer spaces, in for instance hotels or restaurants, or industrial process areas for example used to process or produce food products.

In another embodiment, in a similar manner to the process described above to produce cooling, an absorption cycle may be used to generate heat with for instance an absorption heat pump. In this process the heat of solution generated by dissolving the refrigerant into the absorbent in the absorber and the heat of condensation generated by condensing the refrigerant vapor to refrigerant liquid in the condenser can be transferred to water or some other heat transfer fluid, which is used to heat any space, location, object or body.

In another embodiment, disclosed herein is a process for transferring heat comprising moving a heat transfer fluid from a heat source to a heat sink, wherein the heat source is an absorption cycle utilizing a working fluid pair comprising at least one ionic liquid and at least one fluoroolefin. In this process, the heat sink is any space, location, object, or body requiring heating, including the interior spaces of buildings requiring heating, and industrial processes, among others.

In another embodiment, disclosed herein is a process for transferring heat comprising moving a heat transfer fluid from a heat sink to a heat source, wherein the heat sink is an absorption cycle utilizing a working fluid pair comprising at least one ionic liquid and at least one fluoroolefin. In this process, the heat source is any space, location, object, or body requiring cooling, including the interior spaces of buildings requiring cooling, and industrial processes, among others.

### Apparatus

In one embodiment, disclosed herein is an absorption cycle system apparatus comprising an absorber, a generator, a condenser, an expansion device, and an evaporator, wherein the working fluids contained within said apparatus comprise at least one ionic liquid and at least one fluoroolefin.

In one embodiment, the disclosed apparatus is similar in arrangement to that shown in FIG. 2. In one embodiment, the disclosed apparatus further comprises a heat exchanger.

In another embodiment, disclosed herein is an absorption cycle apparatus comprising an absorber, a generator, a condenser, an expansion device, and an evaporator; wherein the working fluids contained within said apparatus comprise at least one ionic liquid and at least one fluoroolefin; and wherein said apparatus is an absorption chiller.

In another embodiment, disclosed herein is an absorption cycle apparatus comprising an absorber, a generator, a condenser, an expansion device, and an evaporator; wherein the working fluids contained within said apparatus comprise at least one ionic liquid and at least one fluoroolefin; and wherein said apparatus is an absorption heat pump.

The concepts disclosed herein will be further described in the following examples, which do not limit the scope of the invention described in the claims.

### EXAMPLES

### Example 1

### Solubility of trans-HFO-1336mzz in [emim][Tf₂N] Ionic Liquid

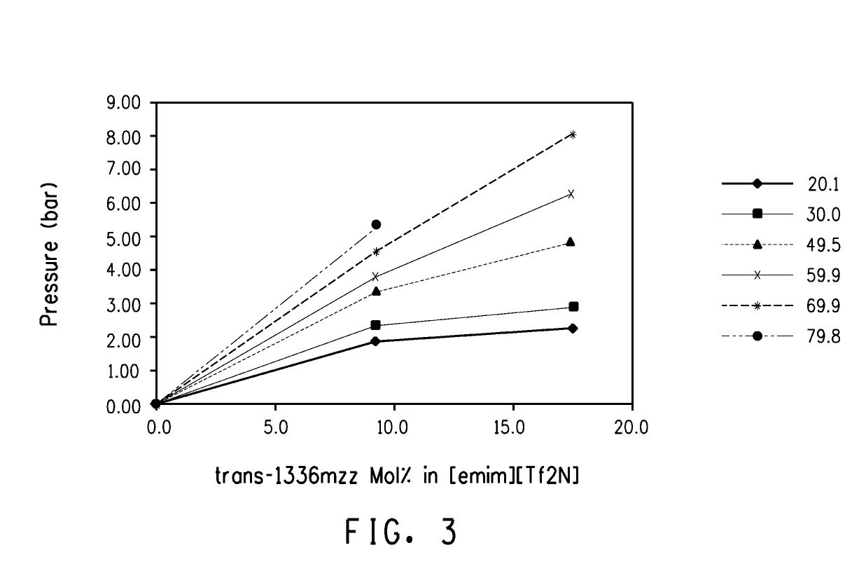

Samples containing 9.4 and 17.3 mole percent trans-HFO-1336m/z in 1-ethyl-3-methylimidazolium bis(trifluoromethylsulfonyl)imide ionic liquid (abbreviated [emim][Tf₂N]) were prepared and the pressure was measured at temperatures ranging from 20° C. to 80° C. The data is shown in FIG. 3 and Table 4.

The fluoroolefin trans-HFO-1336mzz was prepared by reaction of CF₃I with 3,3,3-trifluoropropene (CF₃CH═CH₂) to produce CF₃CH₂CHICF₃, which was then reacted KOH to form the CF₃CH═CHCF₃ (as described herein as well as in J. of Fluorine Chemistry, 4 (1974), 261-270.). The ionic liquid 1-ethyl-3-methylimidazolium bis(trifluoromethylsulfonyl)imide, [emim][Tf₂N], (electrochemical grade, ≧99.5%, C₈H₁₁F₆N₃O₄S₂) was purchased from Covalent Associates Inc. (Corvallis, Oreg.).

TABLE 4
Vapor-Liquid Equilibria for binary
mixtures of trans-HFO-1336mzz and [emim]Tf₂N]

Pressure (bar)

| Temperature (° C.) | 9.3 mole % | 17.3 mole % |
|---|---|---|
| 20.1 | 1.94 | 2.23 |
| 30.0 | 2.28 | 2.93 |
| 49.5 | 3.36 | 4.88 |
| 59.9 | 3.81 | 6.23 |
| 69.9 | 4.53 | 8.00 |
| 79.8 | 5.11 | not measured |

The data in Table 4 indicates that the trans-HFO-1336mzz is soluble in the ionic liquid [emim][Tf₂N] indicating that these compounds would function as a working fluid pair (refrigerant and absorbent) in an absorption cycle system.

### Example 2

### Solubilit of cis-HFO-1336mzz in [emim][Tf₂N] Ionic Liquid

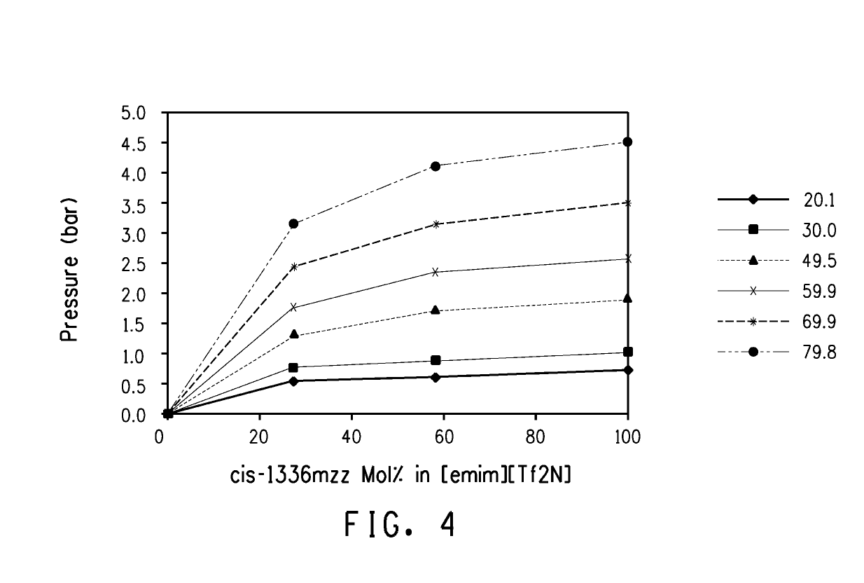

Samples containing 28.0, 58.9, and 100 mole percent cis-HFO-1336mzz in 1-ethyl-3-methylimidazolium bis(trifluoromethylsulfonyl)imide ionic liquid, (abbreviated [emim][Tf₂N]) were prepared and the pressure was measured at temperatures ranging from 20° C. to 80° C. The data is shown in FIG. 4 and Table 5.

The fluoroolefin cis-HFO-1336mzz was prepared by hydrogenation of hexafluoro-2-butyne (CF₃C≡CCF₃) using a Lindlar catalyst, as described in detail in U.S. Patent Publication No. 2008-0269532 A1. The ionic liquid 1-ethyl-3-methylimidazolium bis(trifluoromethylsulfonyl)imide, [emim][Tf₂N], (electrochemical grade, ≧99.5%, C₈H₁₁F₆N₃O₄S₂) was purchased from Covalent Associates Inc. (Corvallis, Oreg.).

TABLE 5
Vapor-Liquid Equilibria for binary
mixtures of cis-HFO-1336mzz and [emim]Tf₂N].

| | Pressure (bar) | | |
|---|---|---|---|
| Temperature (° C.) | 28.0 mol % | 58.9 mol % | 100 mol % |
| 20.1 | 0.5 | 0.6 | 0.7 |
| 30.0 | 0.7 | 0.9 | 1.0 |
| 49.5 | 1.3 | 1.7 | 1.0 |
| 59.9 | 1.8 | 2.4 | 2.6 |
| 69.9 | 2.4 | 3.1 | 3.4 |
| 79.8 | 3.1 | 4.1 | 4.5 |

The data in Table 5 indicates that the cis-HFO-1336mzz is soluble in the ionic liquid [emim][Tf₂N] indicating that these compounds would function as a working fluid pair (refrigerant and absorbent) in an absorption cycle system.

What is claimed is:

1. A composition comprising at least one ionic liquid and at least one fluoroolefin, wherein said composition comprises at least about 1 weight percent of said at least one fluoroolefin.

2. The composition of claim 1 wherein said ionic liquid comprises at least one cation selected from the group consisting of: 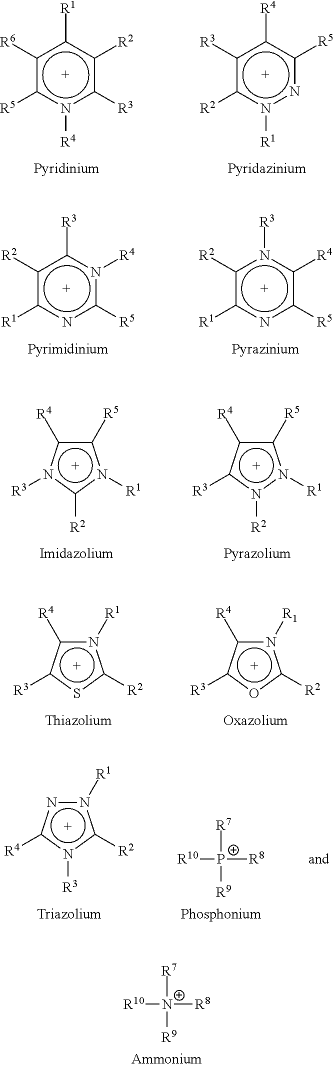
wherein R¹, R², R³, R⁴, R⁵ and R⁶ are each independently selected from the group consisting of:
(i) H;
(ii) halogen;
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₃ to C₂₅ unsubstituted heteroaryl having one to three heteroatoms independently selected from the group consisting of O, N, Si and S; and
(vi) C₆ to C₂₅ substituted aryl, or C₃ to C₂₅ substituted heteroaryl having one to three heteroatoms independently selected from the group consisting of O, N, Si and S; wherein said substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
(2) OH,
(3) NH₂, and
(4) SH; and
(vii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(viii) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of CI, Br, F, I, OH, NH₂ and SH;
(ix) C₆ to C₂₅ unsubstituted aryl, or C₃ to C₂₅ unsubstituted heteroaryl having one to three heteroatoms independently selected from the group consisting of O, N, Si and S; and
(x) C₆ to C₂₅ substituted aryl, or C₃ to C₂₅ substituted heteroaryl having one to three heteroatoms independently selected from the group consisting of O, N, Si and S; wherein said substituted aryl or substituted heteroaryl has one to three substituents independently selected from the group consisting of:
(1) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
(2) OH,
(3) NH₂, and
(4) SH; and
wherein optionally at least two of R¹, R², R³, R⁴, R⁵, R⁶, R⁷, R⁸, R⁹, and R¹⁰ can together form a cyclic or bicyclic alkanyl or alkenyl group.

3. The composition of claim 2 wherein any one of, or any group of more than one of, R¹, R², R³, R⁴, R⁵, R⁶, R⁷, R⁸, R⁹ and R¹⁰ comprises F—.

4. The composition of claim 1 wherein an ionic liquid comprises an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻ and any fluorinated anion.

5. The composition of claim 3 wherein the fluorinated anion is selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]—, [(CF₃CFHCF₂SO₂)₂N]⁻, and F⁻.

6. The composition of claim 1 wherein said fluoroolefin is at least one compound selected from the group consisting of:
(i) fluoroolefins of the formula E- or Z—R¹CH═CHR², wherein R¹ and R² are, independently, C₁ to C₆ perfluoroalkyl groups;
(ii) cyclic fluoroolefins of the formula cyclo-[CX═CY(CZW)ₙ-], wherein X, Y, Z, and W, independently, are H or F, and n is an integer from 2 to 5; and
(iii) fluoroolefins selected from the group consisting of:
tetrafluoroethylene (CF₂═CF₂); hexafluoropropene (CF₃CF═CF₂); 1,2,3,3,3-pentafluoro-1-propene (CHF═CFCF₃), 1,1,3,3,3-pentafluoro-1-propene (CF₂═CHCF₃), 1,1,2,3,3-pentafluoro-1-propene (CF₂═CFCHF₂), 1,2,3,3-tetrafluoro-1-propene (CHF═CFCHF₂), 2,3,3,3-tetrafluoro-1-propene (CH₂═CFCF₃), 1,3,3,3-tetrafluoro-1-propene (CHF═CHCF₃), 1,1,2,3-tetrafluoro-1-propene (CF₂═CFCH₂F), 1,1,3,3-tetrafluoro-1-propene (CF₂═CHCHF₂), 1,2,3,3-tetrafluoro-1-propene (CHF═CFCHF₂), 3,3,3-trifluoro-1-propene (CH₂═CHCF₃), 2,3,3-trifluoro-1-propene (CHF₂CF═CH₂); 1,1,2-trifluoro-1-propene (CH₃CF═CF₂); 1,2,3-trifluoro-1-propene (CH₂FCF═CF₂); 1,1,3-trifluoro-1-propene (CH₂FCH═CF₂); 1,3,3-trifluoro-1-propene (CHF₂CH═CHF); 1,1,1,2,3,4,4,4-octafluoro-2-butene (CF₃CF═CFCF₃); 1,1,2,3,3,4,4,4-octafluoro-1-butene (CF₃CF₂CF═CF₂); 1,1,1,2,4,4,4-heptafluoro-2-butene (CF₃CF═CHCF₃); 1,2,3,3,4,4,4-heptafluoro-1-butene (CHF═CFCF₂CF₃); 1,1,1,2,3,4,4-heptafluoro-2-butene (CHF₂CF═CFCF₃); 1,3,3,3-tetrafluoro-2-(trifluoromethyl)-1-propene ((CF₃)₂C═CHF); 1,1,3,3,4,4,4-heptafluoro-1-butene (CF₂═CHCF₂CF₃); 1,1,2,3,4,4,4-heptafluoro-1-butene (CF₂═CFCHFCF₃); 1,1,2,3,3,4,4-heptafluoro-1-butene (CF₂═CFCF₂CHF₂); 2,3,3,4,4,4-hexafluoro-1-butene (CF₃CF₂CF═CH₂); 1,3,3,4,4,4-hexafluoro-1-butene (CHF═CHCF₂CF₃); 1,2,3,4,4,4-hexafluoro-1-butene (CHF═CFCHFCF₃); 1,2,3,3,4,4-hexafluoro-1-butene (CHF═CFCF₂CHF₂); 1,1,2,3,4,4-hexafluoro-2-butene (CHF₂CF═CFCHF₂); 1,1,1,2,3,4-hexafluoro-2-butene (CH₂FCF═CFCF₃); 1,1,1,2,4,4-hexafluoro-2-butene (CHF₂CH═CFCF₃); 1,1,1,3,4,4-hexafluoro-2-butene (CF₃CH═CFCHF₂); 1,1,2,3,3,4-hexafluoro-1-butene (CF₂═CFCF₂CH₂F); 1,1,2,3,4,4-hexafluoro-1-butene (CF₂═CFCHFCHF₂); 3,3,3-trifluoro-2-(trifluoromethyl)-1-propene (CH₂═C(CF₃)₂); 1,1,1,2,4-pentafluoro-2-butene (CH₂FCH═CFCF₃); 1,1,1,3,4-pentafluoro-2-butene (CF₃CH═CFCH₂F); 3,3,4,4,4-pentafluoro-1-butene (CF₃CF₂CH═CH₂); 1,1,1,4,4-pentafluoro-2-butene (CHF₂CH═CHCF₃); 1,1,1,2,3-pentafluoro-2-butene (CH₃CF═CFCF₃); 2,3,3,4,4-pentafluoro-1-butene (CH₂═CFCF₂CHF₂); 1,1,2,4,4-pentafluoro-2-butene (CHF₂CF═CHCHF₂); 1,1,2,3,3-pentafluoro-1-butene (CH₃CF₂CF═CF₂); 1,1,2,3,4-pentafluoro-2-butene (CH₂FCF═CFCHF₂); 1,1,3,3,3-pentafluoro-2-methyl-1-propene (CF₂═C(CF₃)(CH₃)); 2-(difluoromethyl)-3,3,3-trifluoro-1-propene (CH₂═C(CHF₂)(CF₃)); 2,3,4,4,4-pentafluoro-1-butene (CH₂═CFCHFCF₃); 1,2,4,4,4-pentafluoro-1-butene (CHF═CFCH₂CF₃); 1,3,4,4,4-pentafluoro-1-butene (CHF═CHCHFCF₃); 1,3,3,4,4-pentafluoro-1-butene (CHF═CHCF₂CHF₂); 1,2,3,4,4-pentafluoro-1-butene (CHF═CFCHFCHF₂); 3,3,4,4-tetrafluoro-1-butene (CH₂═CHCF₂CHF₂); 1,1-difluoro-2-(difluoromethyl)-1-propene (CF₂═C(CHF₂)(CH₃)); 1,3,3,3-tetrafluoro-2-methyl-1-propene (CHF═C(CF₃)(CH₃)); 3,3-difluoro-2-(difluoromethyl)-1-propene (CH₂═C(CHF₂)₂); 1,1,1,2-tetrafluoro-2-butene (CF₃CF═CHCH₃); 1,1,1,3-tetrafluoro-2-butene (CH₃CF═CHCF₃); 1,1,1,2,3,4,4,5,5,5-decafluoro-2-pentene (CF₃CF═CFCF₂CF₃); 1,1,2,3,3,4,4,5,5,5-decafluoro-1-pentene (CF₂═CFCF₂CF₂CF₃); 1,1,1,4,4,4-hexafluoro-2-(trifluoromethyl)-2-butene ((CF₃)₂C═CHCF₃); 1,1,1,2,4,4,5,5,5-nonafluoro-2-pentene (CF₃CF═CHCF₂CF₃); 1,1,1,3,4,4,5,5,5-nonafluoro-2-pentene (CF₃CH═CFCF₂CF₃); 1,2,3,3,4,4,5,5,5-nonafluoro-1-pentene (CHF═CFCF₂CF₂CF₃); 1,1,3,3,4,4,5,5,5-nonafluoro-1-pentene (CF₂═CHCF₂CF₂CF₃); 1,1,2,3,3,4,4,5,5-nonafluoro-1-pentene (CF₂═CFCF₂CF₂CHF₂); 1,1,2,3,4,4,5,5,5-nonafluoro-2-pentene (CHF₂CF═CFCF₂CF₃); 1,1,1,2,3,4,4,5,5-nonafluoro-2-pentene (CF₃CF═CFCF₂CHF₂); 1,1,1,2,3,4,5,5,5-nonafluoro-2-pentene (CF₃CF═CFCHFCF₃); 1,2,3,4,4,4-hexafluoro-3-(trifluoromethyl)-1-butene (CHF═CFCF(CF₃)₂); 1,1,2,4,4,4-hexafluoro-3-(trifluoromethyl)-1-butene (CF₂═CFCH(CF₃)₂); 1,1,1,4,4,4-hexafluoro-2-(trifluoromethyl)-2-butene (CF₃CH═C(CF₃)₂); 1,1,3,4,4,4-hexafluoro-3-(trifluoromethyl)-1-butene (CF₂═CHCF(CF₃)₂); 2,3,3,4,4,5,5,5-octafluoro-1-pentene (CH₂═CFCF₂CF₂CF₃); 1,2,3,3,4,4,5,5-octafluoro-1-pentene (CHF═CFCF₂CF₂CHF₂); 3,3,4,4,4-pentafluoro-2-(trifluoromethyl)-1-butene (CH₂═C(CF₃)CF₂CF₃); 1,1,4,4,4-pentafluoro-3-(trifluoromethyl)-1-butene (CF₂═CHCH(CF₃)₂); 1,3,4,4,4-pentafluoro-3-(trifluoromethyl)-1-butene (CHF═CHCF(CF₃)₂); 1,1,4,4,4-pentafluoro-2-(trifluoromethyl)-1-butene (CF₂═C(CF₃)CH₂CF₃); 3,4,4,4-tetrafluoro-3-(trifluoromethyl)-1-butene ((CF₃)₂CFCH═CH₂); 3,3,4,4,5,5,5-heptafluoro-1-pentene (CF₃CF₂CF₂CH═CH₂); 2,3,3,4,4,5,5-heptafluoro-1-pentene (CH₂═CFCF₂CF₂CHF₂); 1,1,3,3,5,5,5-heptafluoro-1-butene (CF₂═CHCF₂CH₂CF₃); 1,1,1,2,4,4,4-heptafluoro-3-methyl-2-butene (CF₃CF═C(CF₃)(CH₃)); 2,4,4,4-tetrafluoro-3-(trifluoromethyl)-1-butene (CH₂═CFCH(CF₃)₂); 1,4,4,4-tetrafluoro-3-(trifluoromethyl)-1-butene (CHF═CHCH(CF₃)₂); 1,1,1,4-tetrafluoro-2-(trifluoromethyl)-2-butene (CH₂FCH═C(CF₃)₂); 1,1,1,3-tetrafluoro-2-(trifluoromethyl)-2-butene (CH₃CF═C(CF₃)₂); 1,1,1-trifluoro-2-(trifluoromethyl)-2-butene ((CF₃)₂C═CHCH₃); 3,4,4,5,5,5-hexafluoro-2-pentene (CF₃CF₂CF═CHCH₃); 1,1,1,4,4,4-hexafluoro-2-methyl-2-butene (CF₃C(CH₃)═CHCF₃); 3,3,4,5,5,5-hexafluoro-1-pentene (CH₂═CHCF₂CHFCF₃); 4,4,4-trifluoro-2-(trifluoromethyl)-1-butene (CH₂═C(CF₃)CH₂CF₃); 1,1,2,3,3,4,4,5,5,6,6,6-dodecafluoro-1-hexene (CF₃(CF₂)₃CF═CF₂); 1,1,1,2,2,3,4,5,5,6,6,6-dodecafluoro-3-hexene (CF₃CF₂CF═CFCF₂CF₃); 1,1,1,4,4,4-hexafluoro-2,3-bis(trifluoromethyl)-2-butene ((CF₃)₂C═C(CF₃)₂); 1,1,1,2,3,4,5,5,5-nonafluoro-4-(trifluoromethyl)-2-pentene ((CF₃)₂CFCF═CFCF₃); 1,1,1,4,4,5,5,5-octafluoro-2-(trifluoromethyl)-2-pentene ((CF₃)₂C═CHC₂F₅); 1,1,1,3,4,5,5,5-octafluoro-4-(trifluoromethyl)-2-pentene ((CF₃)₂CFCF═CHCF₃); 3,3,4,4,5,5,6,6,6-nonafluoro-1-hexene (CF₃CF₂CF₂CF₂CH═CH₂); 4,4,4-trifluoro-3,3-bis(trifluoromethyl)-1-butene (CH₂═CHC(CF₃)₃); 1,1,1,4,4,4-hexafluoro-3-methyl-2-(trifluoromethyl)-2-butene ((CF₃)₂C═C(CH₃)(CF₃)); 2,3,3,5,5,5-hexafluoro-4-(trifluoromethyl)-1-pentene (CH₂═CFCF₂CH(CF₃)₂); 1,1,1,2,4,4,5,5,5-nonafluoro-3-methyl-2-pentene (CF₃CF═C(CH₃)CF₂CF₃); 1,1,1,5,5,5-hexafluoro-4-(trifluoromethyl)-2-pentene (CF₃CH═CHCH(CF₃)₂); 3,4,4,5,5,6,6,6-octafluoro-2-hexene (CF₃CF₂CF₂CF═CHCH₃); 3,3,4,4,5,5,6,6-octafluoro1-hexene (CH₂═CHCF₂CF₂CF₂CHF₂); 1,1,1,4,4-pentafluoro-2-(trifluoromethyl)-2-pentene ((CF₃)₂C═CHCF₂CH₃); 4,4,5,5,5-pentafluoro-2-(trifluoromethyl)-1-pentene (CH₂═C(CF₃)CH₂C₂F₅); 3,3,4,4,5,5,5-heptafluoro-2-methyl-1-pentene (CF₃CF₂CF₂C(CH₃)═CH₂); 4,4,5,5,6,6,6-heptafluoro-2-hexene (CF₃CF₂CF₂CH═CHCH₃); 4,4,5,5,6,6,6-heptafluoro-1-hexene (CH₂═CHCH₂CF₂C₂F₅); 1,1,1,2,2,3,4-heptafluoro-3-hexene (CF₃CF₂CF═CFC₂H₅); 4,5,5,5-tetrafluoro-4-(trifluoromethyl)-1-pentene (CH₂═CHCH₂CF(CF₃)₂); 1,1,1,2,5,5,5-heptafluoro-4-methyl-2-pentene (CF₃CF═CHCH(CF₃)(CH₃)); 1,1,1,3-tetrafluoro-2-(trifluoromethyl)-2-pentene ((CF₃)₂C═CFC₂H₅); 1,1,1,2,3,4,4,5,5,6,6,7,7,7-tetradecafluoro-2-heptene (CF₃CF═CFCF₂CF₂C₂F₅); 1,1,1,2,2,3,4,5,5,6,6,7,7,7-tetradecafluoro-3-heptene (CF₃CF₂CF═CFCF₂C₂F₅); 1,1,1,3,4,4,5,5,6,6,7,7,7-tridecafluoro-2-heptene (CF₃CH═CFCF₂CF₂C₂F₅); 1,1,1,2,4,4,5,5,6,6,7,7,7-tridecafluoro-2-heptene (CF₃CF═CHCF₂CF₂C₂F₅); 1,1,1,2,2,4,5,5,6,6,7,7,7-tridecafluoro-3-heptene (CF₃CF₂CH═CFCF₂C₂F₅); and 1,1,1,2,2,3,5,5,6,6,7,7,7-tridecafluoro-3-heptene (CF₃CF₂CF═CHCF₂C₂F₅).

7. The process of claim 6, wherein said fluoroolefin is selected from the group consisting of:
1,1,1,4,4,4-hexafluorobut-2-ene; 1,1,1,4,4,5,5,5-octafluoropent-2-ene; 1,1,1,4,4,5,5,6,6,6-decafluorohex-2-ene; 1,1,1,4,5,5,5-heptafluoro-4-(trifluoromethyl)pent-2-ene; 1,1,1,2,2,5,5,6,6,6-decafluorohex-3-ene; 1,1,1,4,4,5,5,6,6,7,7,7-dodecafluorohept-2-ene; 1,1,1,4,4,5,6,6,6-nonafluoro-5-(trifluoromethyl)hex-2-ene; 1,1,1,4,5,5,6,6,6-nonfluoro-4-(trifluoromethyl)hex-2-ene; 1,1,1,5,5,5-hexafluoro-4,4-bis(trifluoromethyl)pent-2-ene; 1,1,1,2,2,5,5,6,6,7,7,7-dodecafluorohept-3-ene; 1,1,1,2,2,5,6,6,6-nonafluoro-5-(trifluoromethyl)hex-3-ene; 1,1,1,4,4,5,5,6,6,7,7,8,8,8-tetradecafluorooct-2-ene; 1,1,1,4,4,5,5,6,7,7,7-undecafluoro-6-(trifluoromethyl)hept-2-ene; 1,1,1,5,5,6,6,6-octafluoro-4,4-bis(trifluoromethyl)hex-2-ene; 1,1,1,2,2,5,5,6,6,7,7,8,8,8-tetradecafluorooct-3-ene; 1,1,1,2,2,5,5,6,7,7,7-undecafluoro-6-(trifluoromethyl)hept-3-ene; 1,1,1,2,2,5,6,6,7,7,7-undecafluoro-5-(trifluoromethyl)hept-3-ene; 1,1,1,2,2,6,6,6-octafluoro-5,5-bis(trifluoromethyl)hex-3-ene; 1,1,1,2,2,3,3,6,6,7,7,8,8,8-tetradecafluorooct-4-ene; 1,1,1,2,5,6,6,6-octafluoro-2,5-bis(trifluoromethyl)hex-3-ene; 1,1,1,2,5,5,6,6,7,7,7-undecafluoro-2-(trifluoromethyl)hept-3-ene; 1,1,1,4,4,5,5,6,6,7,7,8,8,9,9,9-hexadecafluoronon-2-ene; 1,1,1,4,5,5,6,6,7,7,8,8,8-tridecafluoro-4-(trifluoromethyl)hept-2-ene; 1,1,1,6,6,6-octafluoro-4,4-bis(trifluoromethyl)hept-2-ene; 1,1,1,2,2,5,5,6,6,7,7,8,8,9,9,9-hexadecafluoronon-3-ene; 1,1,1,2,2,5,5,6,6,7,8,8,8-tridecafluoro-7-(trifluoromethyl)oct-3-ene; 1,1,1,2,2,6,6,7,7,7-decafluoro-5,5-bis(trifluoromethyl)hept-3-ene; 1,1,1,2,2,3,3,6,6,7,7,8,8,9,9,9-hexadecafluoronon-4-ene; 1,1,1,2,2,3,3,6,6,7,8,8,8-tridecafluoro-7-(trifluoromethyl)oct-4-ene; 1,1,1,2,2,3,3,6,7,7,8,8,8-tridecafluoro-6-(trifluoromethyl)oct-4-ene; 1,1,1,5,5,6,6,7,7,7-decafluoro-2,2-bis(trifluoromethyl)hept-3-ene; 1,1,1,2,5,5,6,6,7,7,8,8,8-tridecafluoro-2(trifluoromethyl)oct-3-ene; 1,1,1,2,5,5,6,7,7,7-decafluoro-2,6-bis(trifluoromethyl)hept-3-ene; 1,1,1,2,5,6,6,7,7,7-decafluoro-2,5-bis(trifluoromethyl)hept-3-ene; 1,1,1,2,6,6,6-heptafluoro-2,5,5-tris(trifluoromethyl)hex-3-ene; 1,1,1,2,2,5,5,6,6,7,7,8,8,9,9,10,10,10-octadecafluorodec-3-ene; 1,1,1,2,2,5,6,6,7,7,8,8,9,9,9-pentadecafluoro-5-(trifluoromethyl)non-3-ene; 1,1,1,2,2,6,6,7,7,8,8,8-dodecafluoro-5,5-bis(trifluoromethyl)oct-3-ene; 1,1,1,2,2,3,3,6,6,7,7,8,8,9,9,10,10,10-octadecafluorodec-4-ene; 1,1,1,2,2,3,3,6,6,7,7,8,9,9,9-pentadecafluoro-8-(trifluoromethyl)non-4-ene; 1,1,1,2,2,3,3,7,7,8,8,8-dodecafluoro-6,6-bis(trifluoromethyl)oct-4-ene; 1,1,1,2,5,5,6,6,7,7,8,8,9,9,9-pentadecafluoro-2-(trifluoromethyl)non-3-ene; 1,1,1,2,5,5,6,6,7,8,8,8-dodecafluoro-2,7-bis(trifluoromethyl)oct-3-ene; 1,1,1,2,6,6,7,7,7-nonafluoro-2,5,5-tris(trifluoromethyl)hept-3-ene; 1,1,1,2,2,3,3,4,4,7,7,8,8,9,9,10,10,10-octadecafluorodec-5-ene; 1,1,1,2,3,3,6,6,7,7,8,8,9,9,9-pentadecafluoro-2-(trifluoromethyl)non-4-ene; 1,1,1,2,2,3,6,6,7,7,8,8,9,9,9-pentadecafluoro-3-(trifluoromethyl)non-4-ene; 1,1,1,5,5,6,6,7,7,8,8,8-dodecafluoro-2,2,-bis(trifluoromethyl)oct-3-ene; 1,1,1,2,3,3,6,6,7,8,8,8-dodecafluoro-2,7-bis(trifluoromethyl)oct-4-ene; 1,1,1,2,3,3,6,7,7,8,8,8-dodecafluoro-2,6-bis(trifluoromethyl)oct-4-ene; 1,1,1,5,5,6,7,7,7-nonafluoro-2,2,6-tris(trifluoromethyl)hept-3-ene; 1,1,1,2,2,3,6,7,7,8,8,8-dodecafluoro-3,6-bis(trifluoromethyl)oct-4-ene; 1,1,1,2,2,3,6,7,7,8,8,8-dodecafluoro-3,6-bis(trifluoromethyl)oct-4-ene; 1,1,1,5,6,6,7,7,7-nonafluoro-2,2,5-tris(trifluoromethyl)hept-3-ene; and 1,1,1,6,6,6-hexafluoro-2,2,5,5-tetrakis(trifluoromethyl)hex-3-ene.

8. The process of claim 6, wherein said fluoroolefin is selected from the group consisting of:
1,2,3,3,4,4-hexafluorocyclobutene; 3,3,4,4-tetrafluorocyclobutene; 3,3,4,4,5,5,-hexafluorocyclopentene; 1,2,3,3,4,4,5,5-octafluorocyclopentene; and 1,2,3,3,4,4,5,5,6,6-decafluorocyclohexene.

9. The composition of claim 1 comprising from about 1 weight percent to about 99 weight percent of at least one ionic liquid and from about 99 weight percent to about 1 weight percent of at least one fluoroolefin.

10. A process for producing cooling comprising
a. forming a refrigerant/absorbent mixture,
b. heating said mixture to release refrigerant vapor,
c. condensing said refrigerant to form liquid refrigerant,
d. evaporating said liquid refrigerant in the vicinity of a heat transfer fluid,
e. transferring said heat transfer fluid to the vicinity of a body to be cooled, and
f. reforming the absorbent/refrigerant solution;
wherein said refrigerant/absorbent mixture comprises at least one ionic liquid and at least one fluoroolefin.

11. A process for transferring heat comprising moving a heat transfer fluid from a heat source to a heat sink, wherein the heat source is an absorption cycle utilizing a working fluid pair comprising at least one ionic liquid and at least one fluoroolefin.

12. An absorption cycle system apparatus comprising an absorber, a generator, a condenser, an expansion device, and an evaporator, wherein the working fluids contained within said apparatus comprise at least one ionic liquid and at least one fluoroolefin.
